(19) United States
(12) Patent Application Publication
(10) Pub. No.: US 2008/0071789 A1
(43) Pub. Date: Mar. 20, 2008

(54) IFSLGOVWATCH

(76) Inventor: Staniey Anthony Kwasiborski, Grosse Ile, MI (US)

Correspondence Address: STANIEY ANTHONY KWASIBORSKI III, P.O. BOX 174, NEWBERRY, MI, 49868, US

(21) Appl. No.: 11/515,515

(22) Filed: Sep. 1, 2006

(51) Int. Cl. G06F 17/30

(52) U.S. Cl. 707/10

(57) ABSTRACT

IFSLGOVWATCH provides a methodically unique instrument within the realm of intellect as it so relates to the field of political science. Tangible application aspect utilizes the numerous, well-known facets of mass media (FFDI/FFDS/FFDR—FT) to provide highly organized, centralized access to geo-govermmental databases from a peripheral or remote vantage point. A decentralized emergency preparedness method is included, as it so relates to the present day field of political science.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Table of Definitions/Acronyms provided after Abstract Section.

### BACKGROUND OF THE INVENTION

IFSLGOVWATCH introduces a new instrument into the political science field. This particular tool resides within the intellectual property realm. The tangible application aspect of this implement is actualized through the numerous and well known multi-media facets (FFDI/FFDS/FFDR—FT) utilizing FOIA'd data with a LINUX operating system. IFSLGOVWATCH addresses chronic and prolific deficits, such as (lack of) access, (lack of) availability, (lack of) expediency, (lack of) organization, (lack of) consistency, (lack of) detail, (lack of) coverage and follow-up coverage, among others within the political science arena at an International, Federal, State and Local level.

The initial IFSLGOVWATCH concept, consisting of ten handwritten pages, was drafted on Aug. 14, 2005 (Gregorian) and approximately twenty copies were mailed to various related domestic addresses (and one foreign) on Aug. 15, 2005. IFSLGOVWATCH was further developed and an additional twenty-nine handwritten pages were subsequently drafted on or before Aug. 28, 2005. A total of forty-three pages were thus mailed to approximately sixteen related domestic addresses on Aug. 29, 2005—one of which being the USPTO. A Provisional Patent was applied for and subsequently granted (US60/713,555) on Sep. 2, 2005. Further development of IFSLGOVWATCH led to IFSLGOVWATCH2 (not Z). This aspect comprised four handwritten pages, drafted on Sep. 5, 2005 and mailed to a number of related domestic addresses on Sep. 6, 2005—one of which being the USPTO. A Provisional Patent was applied for and subsequently granted (US60/714,290) on Sep. 6, 2005. During the twelve month pendency period, aspects and related aspects of IFSLGOVWATCH and IFSLGOVWATCH2 have been further developed.

The initial 1234ABCDCOUNTYSTATUS concept, consisting of thirteen hand-written pages was drafted in the weeks leading up to its mailing on Sep. 3, 2005. A Provisional Patent was granted (US60/714,288) by the USPTO for 1234ABCDCOUNTYSTATUS on Sep. 3, 2005. The thirteen hand-written pages were part of a larger and more comprehensive packet containing twenty-five hand-written pages which were then mailed to approximately eleven related domestic addresses on Sep. 9, 2005 and Sep. 10, 2005.

Home Atlas Encyclopedia to the Solar System and Earth was initially drafted on Apr. 11, 2006 and consisted of five hand-written pages. This draft was subsequently mailed to a number of related domestic addresses that same day, one of which being the USPTO. A Provisional Patent was granted (US60/792,673) on Apr. 18, 2006.

Beginning during the second week of the seventh month (Gregorian) two thousand and six (Roman), the above listed began to be formed into one related field of subject matter under the single title of IFSLGOVWATCH.

### BRIEF SUMMARY OF THE INVENTION

IFSLGOVWATCH is intended to provide convenient, simplistic, expedient, consistent, highly organized access of data—from a multitude of geo-governmental databases across the globe—to the time constrained working class. This implement is actualized through the various forms of mass media (FFDI/FFDSIFFDR—FT) by presenting a method for centralized organizational access from a peripheral or remote vantage point. Also included are a decentralized emergency preparedness plan and an ENCYCLOPEDIC ATLAS, both of which are related by subject matter as it so applies to organizational access within the field of political science.

### BRIEF DESCRIPTION OF THE SEVERAL VIEWS OF THE DRAWING

Not Applicable

### DETAILED DESCRIPTION OF THE INVENTION

In regard to Claim Number One, there is to be provided an entirely new and distinct multi-media market. IFSLGOVWATCH is intended to serve as the doorway to this new marketplace through its useful improvements, methods and process of facilitating and simplifying access to and knowledge of government and governmental operation—its purpose, function, inter workings, provisions, limits, products and byproducts—across the globe.

By utilizing known and existing technological formats, forms, modes and methods of global communication in conjunction with pre-existing governmental databases and freedom of information laws, IFSLGOVWATCH will not only report on (strictly) government, but also provide immediate, direct, organized, CATALOGED access to all government databases, links, feeds and access channels across the globe—from the United Nations to local school boards—to citizens of all Nations through a completely objective, facts only, hands on lens.

Many aspects of IFSLGOVWATCH are intended to provide non bias, non partisan, organized and simplistic access to government facts (databases) across the planet and beyond. This objective, pure access aspect of IFSLGOVWATCH will facilitate the ease of governmental access for all.

IFSLGOVWATCH also provides a detailed methodical approach to disaster management at a local level. This disaster management method is titled 1234ABCDCOUNTYSTATUS and is also designed to employ known and existing technological formats, forms, modes and methods of global communication for its tangible application aspect. 1234ABCDCOUNTYSTATUS necessarily creates its own database at application phase and is presented as a ZONE of IFSLGOVWATCH, functioning through an internet based format during periods of normal operational status.

Home Atlas Encyclopedia to the Solar System and Earth also utilizes known and existing technological formats, forms, modes and methods of global communications in conjunction with pre-existing governmental databases and Freedom of Information Laws to not only provide a new comprehensive method of custom atlas design, but also to facilitate immediate, direct, organized NETWORKCATALOGED access to governmental databases, links, feeds and access channels across the globe as they relate to astronomical and celestial objects and occurrences.

In regard to Claim Number Two, there is provided an internet based domain through which one can access direct live video links of any and all governmental gatherings in their various forms and geographies across the earth. This dependent claim is intended to provide live video access to the UN, International Governments, The EU, the U.S. Federal Government, U.S. State Government and U.S. Local Government, which includes the main branches, agencies, and non agencies as they so apply. Also provided is access to audio and CHARACTER (text). This claim is intended to include not only live video, audio and character links but also access to filed (out of network database) video, audio, and character.

By utilizing known and existing technological formats, forms, modes, and methods of global communication in conjunction with pre-existing governmental databases and Freedom of Information Laws, this claim provides centralized, facilitated, immediate, direct, organized, NETWORKCATALOGED access to government databases, links, feeds and access channels across the globe.

Live video will be accessed via a DDWR search, which provides a direct link to the (known or FOIA'd) out of network host address, and is initiated by a simple to use format icon titled Live Video Feed (which represents VIDEOL1 definition). This icon will be present on all IFSLGOVWATCH PAGES of STUF described in Claim Three. When Live Video Feed icon is initiated within a too broad or non applicable setting, a prompt (file) will appear with “be more specific” text and provide more specific guidance options in icon format.

Live video will provide access ranging from Sadaam Hussein's trial and UN General Assembly (all its main branches, agencies, and non agencies), the EU, the U.S. Supreme Court and the entire U.S. Federal Court System, all State courts, appellates and the entire State court system for all U.S. States, all local, county, city courts throughout the U.S., all other U.S. courts (military, patent, tax, traffic, drug, etc.), the U.S. Legislature (all committees), all fifty State legislatures (all committees), the U.S. Executive, all fifty State executives, all local executives (sheriffs, mayors), all Federal, State, and local agencies such as EPA, State Treasury Departments, right down to county commissions, city councils, college regents and local school boards.

Live video will provide the model applied above on an international level to all participants providing language translation access and a comprehensive current and future events calendar for all. The method of organizing and filing live video (as described under filed video) will be identical for live video, filed video, live audio, filed audio, live character and filed character alike.

Live video is further explained in IFSLGOVWATCH Table of Definitions/Acronyms under DDWR example two, NETWORKCATALOGED example one, IFI example two, and city example two. This live video feature is also utilized as an aspect of (dependent) claim fourteen and twenty-three.

Filed video (VEDEOFI) is identical to live video in its tangible application aspect and scope, except for the fact that out of network databases containing stored video files (VIDEOFI) and accessed via a DDWDR search which contains the (known or FOIA'd) out of network host (file) address. A simple to use format icon titled VDATE (which represents VIDEOFI definition) will be presented identically to live video feed icon as described above.

Filed video will also differ from live video with its post-dated calendar as one form of the term NETWORKCATALOGED. Other NETWORKCATALOGED methods of file organization include by body, chronology, act, bill, topic, hearings, briefings, conferences, investigations, committees, subcommittees, conference committees, voting records, biographies, staff, salaries, pensions, speeches, authors, length, drafters, members, cases, rulings, judgments, opinions, findings, Nation, State, county, city, branch, agency and non agency.

Filed video is further explained in IFSLGOVWATCH Table of Definitions/Acronyms under NETWORKCATALOGED example two and IFI example one.

Live Audio (AUDIOLI) is identical to live video in its tangible application aspect and scope, utilizing NETWORKCATALOGED methods as described above in filed video. Utilizing a DDWR search to access a direct link to the (known or FOIA'd) out of network host address this aspect provides a simple to use format icon titled live audio feed with same parameters as live video feed icon.

Live audio herein applies to the identical governmental scope as for live video (including calendar) and is also utilized as an aspect of (dependent) claim twelve.

Live audio is further explained in IFSLGOVWATCH Table of Definitions/Acronyms under DDWR example one and NETWORKCATALOGED example three.

Filed Audio (AUDIOFI) is identical to filed video in its tangible application and scope. Utilizing a DDWDR search which contains the (known or FOIA'd) out of network host (file) address, a post dated calendar and NETWORKCATALOGED methods as in filed video, this search provides a simple to use format icon titled ADATE, (which represents AUDIOFI definition).

Filed Audio (AUDIOFI) and Filed Video (VIDEOFI) also employ NETWORKCATALOGED methods for News Date (a division of HDATEFILES).

Live Character (CHARACTERLI) is identical to live video (VIDEOLI) and Live Audio (AUDIOLI) in its tangible application aspect, scope, NETWORKCATALOGED methods, calendar and DDWR search.

Live character or text provides a simple to use format icon titled live text (with identical parameters as above). Examples of live character text include a Federal legislator or staffer typing up a portion of a bill with live public access, a State appellate judge or staffer typing a ruling with live public access, a county commissioner or staffer typing drafts with live public access and so on.

Filed Character (CHARACTERFI) is identical for Filed Video (VIDEOFI) and Filed Audio (AUDIOFI) in its tangible application aspect, scope, NETWORKCATALOGED methods, calendar and DDWDR search.

Filed Character provides a simple to use format icon titled CDATE (which represents CHARACTERFI definition).

Filed Character is further explained in IFSLGOVWATCH Table of Definitions/Acronyms under DDWDR example, county example, non-agency example one, and TREASURYFI example.

Maps, pictures and graphics utilize the identical, tangible, application aspect, scope, NETWORKCATALOGED methods, calendar and DDWDR searches as above if and when these three are so accessed in their singular form.

In regard to Claim Three, this internet based domain named IFSLGOVWATCH will provide seven thousand six hundred and twenty-two network ROOTFILES for governmental entities (main branch, agency and non agency) at a UN (36), International (384), Federal (18), State (900), and Local (6282) level. One for NETWORKCATALOGED out of network access and one for CATALOGEDNETWORK access to edited PAGES of STUF. An RVRS icon link will be displayed for each and every governmental entity (main branch, agency and non agency) at a UN and IFSL level to provide access to the corresponding official web site. Corresponding implies the fact that there will be network edited PAGES of STUF (files) provided for each and every governmental entity (main branch, agency and non agency) at a UN and IFSL level. It is these edited PAGES of STUF, within the network domain of IFSLGOVWATCH, to which this claim describes. Approximately forty governmental divisions will be described below, providing a type and cast model which can be further applied to the exponential derivatives and divisions that exist within governments at an International, Federal, State and Local level.

Initial out of network access to IFSLGOVWATCH domain will display a front page (electronically) from a file server within the IFSLGOVWATCH domain but located outside of the actual (firewalls) network. It is this front page which provides a shell for user I.D. access codes as well as an entry shell (file) designed to provide “secure” access to specific zones, for those authorized. Both access shells will be small and at the bottom of the page. Three small icons equally spaced vertically and top spaced horizontally will, in the following order from left to right, have this text: IFSLGOVWATCH, 1234ABCDCOUNTYSTATUS, and HOMEATLAS. Once selection of (one of the three) icons is made, the three icons disappear and the two (above described) access shells then appear along with an icon with the following text, New User Info Please. Selection of the New User icon opens a console in the center of the first page (first page meaning same back-drop graphics remain), which is for sign-on account information. The other two access consoles remain on the first page. Once access is approved, the first (actual) network PAGES of STUF begin to be displayed. Although IFSLGOVWATCHMAIN is custom designed with (exponentially corresponding) PAGES of STUF, there is also available (and accessed through initial access codes) a non graphic, text only LINUX format for those who desire.

The back-drop graphics presented on the first page will display a large and central, color Earth globe video, rotating seven times in two minutes from a selected seven day period of NASA footage, in time lapse video. The remaining eight planets of the Solar System will be in background in color video, rotating on their various axes at rates (from NASA footage in time lapse video) proportional to Earth's selected time lapse rate. The Solar System will revolve at proportional (selected) time lapse rates. The Solar System can be viewed from infinite mobile vantage points which will, of course, determine planet and moon's relative size. All network IFSLGOVWATCH screen will default to this screen saver after a set time. Screen saver parameter variables include speed setting (of which all motion is proportioned) and random setting, which releases planets and moons from orbits as they bounce around the screen, throughout a three dimensional solar system axis as viewed from infinite vantage points throughout the solar system three dimensional axis with planet size proportionally changing relative to vantage point, yet maintaining proportional rotation speed and axis.

Once the (actual) network is accessed, certain standard utility features will be displayed, or able to be displayed, through three main icons at the top of the page. These icons open consoles, which provide an icon list on left upper eighth of page, a search shell top center, and graph icons on right upper sixteenth of page. The icons within the console list on upper left, as well as the graph (pie and linear) icons on upper right will be topic specific to that page (file). Each icon on (opened) upper left icon list will access further icon lists. These further icon lists (third partition) will provide direct access to that requested, further icon lists (fourth partition), informational prompts provided to enter in search shell, or an icon stating, “Be More Specific.” The Be More Specific icon (fourth partition), when accessed, displays simplistic instructions (topic specific) for search methods to be employed. The top center search shell provides direct access to specific files as well as access (displayed identically) to the simplistic instructions located in the Be More Specific file. Graph icons (displayed by accessing the upper right main icon titled, View Graphs) will be topic specific to that page (file) and will primarily display financial information. The upper left console icons (second partition) will be displayed by accessing the upper left main icon titled IFSLGOVWATCH Features. The second partition upper left icon list console will display the following icon list in the following order vertically: Live Video Feed, VDATE, Live Audio Feed, ADATE, Live Text, CDATE, HDATEFILES, GWNN, GWMAG, HOTTSPOTTS, Who Are My Politicians, Environment Watch, Sub Watch, Streaming Audio Central, MVACET, Virtual Tours, Graffiti Watch, Traffic Cams, County Status, Home Atlas, Official Web Page Link, View Constitution, Legislation Search, Judicial Search, Calendar, Religion, Skoolz, Trading Cards, US Involvement, Select Language.

As can be seen in Detailed Description under Claim Two—Filed Video, numerous partitions are required to provide organization within each listed sorting method. This extensive sorting method model is applied across the board to all thirty listed zones where applicable. Third, fourth, fifth, sixth (and so on) partitions will provide icons according to file address, which gives further definition to STUF. The direct file address can (also) be directly accessed through top center SHELLSEARCH.

The first actual network page will display dramatic (interchangeable) United States pictorials as a back-drop, such as Washington crossing the Delaware. Also provided will be a random play option for stirring National audio.

The first network page will display the following titled search icons, evenly and symmetrically spaced, vertically and horizontally. The first (upper row) from left to right will display two icons titled Nations of the World and United States. The second row will display five icons titled UN, EU, Federal, State, and Local. The third row will display seven icons titled Legislative, Executive, Judicial, Legislative, Executive, Judicial, and County. The fourth row will display thirteen icons titled House, Senate, Agency, Non Agency, Agency, Non Agency, House, Senate, Agency, Non Agency, Agency, Non Agency, and City. The fifth (bottom) row will display eight icons titled Agency, Non Agency, Agency, Non Agency, Agency, Non Agency, Agency, and Non Agency. Vertical lines will connect appropriate entities in a pyramid form, for instance one line can be traced from United States (top), then to State, then to Senate, then to Non Agency, thus providing a very simple to use format, graphically. Each icon will either access another PAGE of STUF or provide instruction prompts.

### EXAMPLE 1

Federal Legislative icon will access a generic and first page (partition) regarding the U.S. Legislature, with a brief explanation of its origins and purpose, a back-drop split page with pictorial of House on left and Senate on right with corresponding icons titled House of Representatives and Senate. It is these icons which access the next selected PAGE of STUF, as this description continues to explain.

### EXAMPLE 2

Should county be selected, instruction prompt will request county name and explain character entry process for top center SHELLSEARCH.

### EXAMPLE 3

Should agency be selected under Executive, which is under Federal, which is under United States, then the first generic agency page will be displayed, corresponding to same.

Descriptions herein will proceed laterally and vertically according to the pyramid or reverse tree organization.

Should the icon titled Nations of the World be selected (from first actual network page), the first Nations of the World page will display a large, slowly rotating Earth graphic in center with axial displacement corresponding to season. Light from sun will be projected onto surface. National boundaries will be well defined, as they will serve as and provide icon access to that selected Nation. Nations will also be accessible directly by entering proper name in English followed by language choice (in English) into top center shell. When a Nation is selected by either method, the Earth stops rotating and that particular Nation's geographic outline presents itself onto the (next) page in a slow vectorized form from smaller to entire screen, projecting outward from globe. The Nation presented provides a back-drop of that geography, with that Nation's Flag superimposed. That Nation's main branches of government and agencies will be presented in icon format as described above regarding first network page. Dramatic back-drop pictorials, combined with available, random play audio of a patriotic nature will be provided throughout PAGES of each Nation to present an awareness of Nation. A small globe will serve as a go back icon in the lower left corner. Various provinces and cities will have back-drop PAGES (interchangeable) displaying local landmarks, historic sites or other graphics and pictorials which provide an awareness of the province or city. The pyramid or reverse tree icons will progressively break down governmental superstructure, providing PAGES of STUF for each.

International Governmental breakdown adheres to the same formula explained in detailed description of Claim Twenty, regarding geography. Accessed pie graph icons will, in their second partition, display a round coin from national currency (interchangeable) as back-drop to pie, and paper currency as back-drop to linear. These graphs can be (vectorized) enlarged. This second partition, regarding pie graph, will display (and list below) annual National Governmental budget and highlight a slice.indicating U.S. (total—gross) subsidies in all their forms. A click on this slice of pie provides further breakdowns. Linear graph in second partition is located just to the left of pie graphs and displays the same information regarding U.S. (gross) subsidies in linear, chronological form over twenty years. A click on linear provides detailed annum by annum commentaries and explanations, comparing and contrasting U.S. Administrations and State Department personnel with the selected Nation's Administration and Ambassadors for that year. Each Nation's currency is explained, its history, and its trends. A second pie graph on far right displays (and lists) selected Nation's assets, as a highlighted slice, compared to world (total) assets. A click on this slice provides a page with asset breakdown. Pies, linears and text are utilized to graphically display budgets, mineral assets, military expenditures, social expenditures and others. All of the mapping files are available by Nation, province, city (and etc.), including MAPOFFICELOCATION for U.S. State Department Embassies and Branches as well as for the various branches and agencies of that particular government. The thirty upper left console icons are Nation specific. For example, Environment Watch would be specific to the Nation of India and presented by default in the English language. Live video of the Mumbai City Council Meeting would be, by default, in the English language.

Religion would give a detailed textual history, including national religious breakdown with an emphasis on Christianity—its history, spread, persecutions (current and past) and missions (Catholic and Protestant). A MAPOFFICELOCATION feature for foreign missions and MAPPING 20 graphically displays Christian populations, all presented by default in the English language. Trading Cards would present geographical, political, corporate, and personal biographies regarding selected Nation according to page (topic) and in the English language, by default. The above live video of the Mumbai City Council is accessed either from PAGES of STUF related to Mumbai India or direct from top center SHELLSEARCH with proper character. Official web page link will access Mumbai's official web site while within the Mumbai PAGES of STUF files. Selecting the language Aleutian would then provide the entire above listed regarding India into the Aleutian language, from the live Mumbai City Council Meeting to Environment Watch and all thirty in between.

Streaming Audio Central will NETWORKCATALOG those broadcasts available form the selected Nation to the second selected Nation. For instance, all broadcasts coming out of Afghanistan and available to Australia will be listed, regardless of the forms of transmission—streaming, satellite, long wave, short wave and etc. The Afghanistan file PAGES must be open in order for the thirty options to function. U.S. State Department personnel and subsequent contact information and location will also be available, with the third partition access from second to right pie graph highlighted slice displaying United States gross subsidies. A history of language corresponding to the foreign nation will be provided in the geographical demo-biographies through Trading Cards icon. And, of course, mineral location maps along with all thirty-six mapping files are available through the Home Atlas icon. Thus, the simple to use format (STUF) as applied Internationally.

Back to the first actual network page, should the United Nations icon be selected, the first UN page is displayed with interchangeable, related back-drop pictorials (UN Headquarters, Tower of Babel). A reverse tree, horizontally and vertically aligned, will list icons of the six main organs of the United Nations. Below each will be the icons Agency and Non Agency, thus eighteen icons on the first page—upper left, center, and right icons remain. The various partitions will provide access to all filed video through VDATE icon. HDATEFILES will provide recent filed broadcasts regarding any of the eighteen selections. Live video feed can access UNICEF from either SHELLSEARCH at any time and regardless of page (file) location or from live video feed while within UNICEF PAGES (file). All UN video, audio and Legislation (text) will be organized (and accessible) with the same level of detail explained under Claim Number Two—Filed Video, as to NETWORKCATALOGED methods. Pie graph (second partition) displays (and lists) total annual UN budget with highlighted slice of pie to indicate annual U.S. subsidy, which is also listed numerically.

Trading Cards will provide a back-drop of National Geography, with superimposed National Flag for personal biographies. Political bio-demographies will give insight into all UN branches, agencies and non agencies. SUBWATCH icon will detail those subcontracted entities of the UN. When one of the eighteen icons on first UN PAGE of STUF is selected, a second page is provided with a world flat map back-drop and icons highlight each location across the world which can then be accessed as one of the third UN PAGES. The second UN page will have an icon titled Next, which provides access to one of the third UN PAGES, providing more specific icons relating to that selected on the first page. Constitution icon will access the UN Charter in English, by default. Official Web Page Link icon will access the official web page of that particular organ or organ system page (file) dependent. The European Union will follow a similar pattern as the United Nations. Non agencies and subcontractors will follow AOMB protocol.

In following paragraph will be described simple to use format (STUF) as it applies to the United States, in the following order: Federal Legislative, Federal Executive, Federal Judicial, Federal Agency, Federal Non Agency, State Legislative, State Executive, State Judicial, State Agency, State Non Agency, Local, and City. AOMB protocol will be utilized herein.

Regarding Federal Legislative, when either of the two second PAGES of STUF (partitions) are accessed, various, often interchanged, moving and historic pictorials, as they so relate to each body, will serve as back-drops. Random play audio will be available, as a partition file in ADATE, which when opted, provides historic music conveying a sense of Nation, National History, and National Pride. Eight icons will be evenly spaced, vertically and horizontally, atop back-drop. These eight icons will provide (access) further detail (partitions) on PAGES of STUF as to the current status of the selected body and will be titled as follows: Who's Here, Today's Votes, Status of Floor, Today's Cost, Full Committees, Sub Committees, Conference Committees, and Current Legislation. Status of floor icon, when accessed, will not only provide the current floor activity, but will provide a two day only calendar (CALENDARFIPOLITICAL) which not only lists the next twenty-four hour schedule, but also lists the previous twenty-four hour period activities for that body. The previous twenty-four hour activity will provide the following twenty-two (evenly spaced—vertically and horizontally) icons which, as the title implies, not only provide more detailed accessibility to the previous twenty-four hour period, but also demonstrate a NETWORKCATALOGED sorting and filing method utilized for all previous Legislative activity. Those twenty-two icons are: Body, Day Chronology, Date Chronology, Act, Bill, Topic, Member, Staffer, Contributing Members, Speeches, Length, Generated Documents, Committee, Subcommittee, Conference Committee, Voting Record, Session, Meeting, Hearing, Briefing, Conference, and Investigation. Today's cost will total (from bio-demographies) all daily expenses of members, staff, salaries, benefits, pensions, rents, utilities and other, to provide a gross figure for operation of particular body over previous twenty-four hours. Full Committee, Subcommittee, and Conference Committee icons will provide detailed review, current live video feed specific to PAGE (file), live audio feed, live text, and upcoming twenty-four hour schedule. Current Legislation icon lists any and all current drafts, proposals, tabled, pending (or otherwise) legislation by body and applies the above listed twenty-two methods of sorting (where applicable) provided by NETWORKCATALOGED feature.

Legislation search provides two features. The first is actually a NETWORKCATALOGED CDATE search for all previous legislation. The second (a third partition) icon is titled Track a Bill Backwards. This feature places the specific selected enacted Legislation in a historic, political and social context—providing a Legislation bio-demography as it applies to each and all. Track a Bill Backwards also provides a reverse tree view of each and every enacted Legislation by tracking backwards its various sections beginning with body(s), committees(s), subcommittee(s), conference committee(s), lead proponents, authors, drafters, and staffers. This track a Bill Backwards feature not only lists each contributing member, but also lists each contributing staffer, providing detail as to hours expended by each member and by each member's staffer each day. Total hours are then added for each member at each phase of the process. Example: Senator Smith spent six hours on draft Legislation in conference committee on a particular day. Two of his staff (Staffer seventy-two and Staffer forty-eight) spent seven and a quarter and nine and three quarter hours, respectively that same day on that same draft. Six days total in conference committee are also added. The same formula is applied for each member and staff daily and at each phase of the Legislative process—subcommittee, full committee, back to subcommittee, etc. Thus, the Legislation is totaled in cost and hours with an appendix listing each and every contributor, hours, contributional section and cost (by subdividing annual salary into hours and then adding). The left console icon titled Calendar (CALENDARFIPOLITICAL) will superimpose the specific or generic political calendar of events page (file) location, dependent upon the accepted Roman calendar with two options (third partition icon), one week and one month. Thus, if the one month calendar icon is selected while user is viewing generic and first page (partition), two thirds of the screen (PAGE of STUF) will be covered (centrally and symmetrically) with a one month calendar regarding upcoming events for both Houses. Should live video feed be initiated on this same page, a split screen will be displayed of live current activity in the House of Representatives on left and Senate on right. Live audio is automatically engaged with all live video. Live audio refers primarily to audio only access and databases (in the case of ADATE). Should user be located on a PAGE of STUF regarding a conference committee and one week calendar selection is made, a linear and horizontally rectangular week-long calendar will be displayed, beginning at that moment, occupying one third of the screen centrally and providing CALENDARFI Political superimposed on Roman calendar as political schedule pertains to that specific conference committee. Should live video feed be selected while user is located on this same PAGE of STUF, direct, live, current activity (with audio) of that particular conference committee is displayed. Filed video (VDATE) will adhere to similar model, providing NETWORKCATALOGED access lists specific to PAGE of STUF. Official Web Page Links will be page specific, as will all left shell console icons and right side graphics. GWMAG and GWNN derive much of their information from the utilization of the various above listed sorting and filing methods, whether NETWORKCATALOGED or CATALOGEDNETWORK. HDATE will provide sixty second (current) filed broadcasts with summaries as page topic (file) specific. Personal bio-demographies of members and staffers will utilize graph icons to display salaries, staff, gross daily cost to tax-payer of each member (staff and all). Personnel member bio-demographies will provide detailed fund breakdown (and sources) for current and all past campaigns with all campaign ads (previous, current—audio, video) NETWORKCATALOGED. Bio-demographies will list all committees (conference, sub, full), hearings, investigations, panels, or other—previous and current. Bio-demographies will list all staff—previous and current. Bio-demographies will list detailed environmental record and any and all subcontractor affiliations. Icons for Subcommittees, Conference Committees, and Full Committees, when accessed on second Legislative PAGE of STUF also provide via attached icon titled History, a unique (file) history of that particular committee. This stand-alone committee history is independent of members who come and go.

In regard to the Federal Executive, page one of STUF will display a historic and related, interchangeable pictorial back-drop such as the White House. Executive applied at a State level refers to Governor and at a Local level refers to Sheriff and Mayor. Although access to Federal Agencies and Federal Non Agencies is through this page, the executive PAGES of STUF primarily deals with executive activity, executive documents, executive staff, executive operating costs (with and without agencies), schedule, speeches, and press conferences. Bio-demographies will be provided for all U.S. Presidents. Left console icon and right graph icon will be so related to Executive Branch as well as to page/topic (file) location. Trading Cards will provide not only bio-demographies for past Presidents, but will also provide a command RIDER which adjusts entire left console of icons and right console of graphs to that particular President, Administration, and chronology. (Example: The Watergate tapes will be available (ADATE) through NETWORKCATALOGED access while within Richard Milhous Nixon PAGES of STUF (file). Filed video (VDATE) follows the same pattern. Of course, the actual address can be entered in top, upper center shell to gain file access, regardless of (file) page.

In regard to Federal Judicial, when any of the three icons (Judicial, Agency, Non Agency) are engaged from the first actual network page of STUF, the same first Federal Judicial page is accessed. Back-drops throughout the Judiciary, at all levels, will provide a back-drop with various, often interchanged, moving and historic pictorials as they so relate to specific court or court system. Back-drop will present gold fringe around frame of page (screen) dangling inward, as that which is around U.S. Flag in court systems of Admiralty Jurisdiction. This fringe will be displayed as part of back-drop pictorials for each and every U.S. Court under Admiralty Jurisdiction (at all Federal, State and Local levels) and will not be displayed for those courts not under Admiralty Jurisdiction. Twenty-five icons will be provided on this first page in five rows, evenly arranged, vertically and horizontally, with vertical lines connecting corresponding icons. The first and centered icon on first row is titled Supreme Court. The second row contains seven icons titled Federal Appellate (listing title and location), the last of which being other courts. The third row is identical to the second row, except for the last icon which is titled Non Geographic Federal Appellate. The fourth row contains six icons titled Federal District (with a numeric amount) and are so connected with vertical lines to corresponding Federal Appellate. The last line is identical to the fourth. The approximately ninety Federal District Courts are grouped according to Appellate Jurisdiction. These icons will access the selected entity, providing detailed demographics for each. Left console icons and right pie graph icons will provide access and information specific to selected page/topic (file) as described above for Federal Legislative. Other Courts icon accesses a second page which lists the various tax, military, patent, FISA, and other courts at a Federal level.

Federal District Court icon will access a second PAGE of STUF providing icons titled according to each District Court's official name. Twelve separate PAGES of STUF will be provided for the Federal District Court System according to Appellate Jurisdiction, which was previously identified on first Federal Judicial PAGE of STUF with vertical line connects. Judicial Search icon located in left console provides four features, all of which are page (file) dependent. The subsequent partitioned icons of Judicial Search icon represent file organization. Judicial Search icon engagement displays four icons which represent the four features and are in vertical order: JUDICIALRULINGSFI, SEARCHBY, LAWBOOKS, and CRIMESTATS. Multiple fourth, fifth, sixth (and so on) partitions narrow search parameters in this simple to use format. JUDICIALRULINGSFI is actually a NETWORKCATALOGED CDATE search providing page/topic specific searches of judicial activity. Search by icon (and multiple partitions) not only provides insight into the NETWORKCATALOGED sorting and file method, but also avails itself to the network user in a simple to use format (STUF). The Search By icon provides the following NETWORKCATALOGED methods of file organization as it relates to the Judiciary—(sorted) Search By: Branch, System, Court, chronology, topic, proceedings, biographies, staff, salary, revenue, pension, authors, length, Cases, Rulings, Judgments, Opinions, Findings, Statutes Forming Decision, Nation, State, County, City, current, and previous. Law Books icon provides NETWORKCATALOGED access to all compiled laws at an International, Federal (UCC, CFR, etc.) and State (Statutory, compiled, etc.) level. CRIMESTATS icon provides current and previous detailed crime statistics in major and minor categories. Federal Judicial PAGES of STUF will cause Judicial Search icons to access Federal Judicial Rulings (JUDICIALRULINGSFI), search types as it relates to Federal Judicial Rulings (search by) and Federal Compiled Law such as Uniform Commercial Code and Code of Federal Regulations (law books). Crime statistics will be subsequently compiled at a Federal vantage point (CRIMESTATS). State Judicial PAGES of STUF will alternatively provide State Judicial Rulings (JUDICIALRULINGSFI). Search types as it relates to specific State Judicial Rulings (SEARCHBY), State Compiled Statutory Laws specific to State (LAWBOOKS), crime statistics which are State specific (CRIMESTATS). Local Judicial PAGES of STUF will alternatively provide Local Judicial Rulings (JUDICIALRULINGSFI), Local Compiled Laws which would include County and City Ordinances (Law Books) and Local crime statistics by County and/or City (CRIMESTATS). Of course, State and Local Judicial PAGES of STUF will also provide page/topic (file) specific utilization of not only the thirty icons located in left console, but also the graph icons on right. Back to the Federal Judiciary (yet applicable to all). For each Court (house), certain bio-demographies will be provided, including personnel, budget, operating cost, history, contact info, pictorials and revenue in what is referred to as a courthouse bio-demography and is available through a file partition. An example of judicial revenue is that non appropriated budgetary operation cost; those accounts of revenue generated through various costs, fees, and fines attached to the Judicial Ruling. These separate revenue accounts are then detailed as to their corresponding reinvestment programs. Pie and linear graphs will provide graphic presentations of revenue breakdowns and other financial operations. Judicial personal biographies will also include years on the bench, staff, history, campaign fund breakdown, subcontractor ties and environmental record. HDATEFILES will provide current one minute recorded broadcasts for each court (house) for each day. Live video feed will provide visual access to the one hundred plus court houses within the Federal Judiciary according to page/topic (file). Filed video (VDATE) will provide visual access to previous activity of the one hundred plus Courthouses within the Federal Judiciary. Live text will access rulings, transcripts, and stenographs “Right Off the Wire” for above listed. Official Web Page Link will be available, page and/or Courthouse specific. All communications will be provided in the English language (by default). MAPOFFICELOCATION, CALENDARPOLITICALFI, and all others will be page/topic (file) specific. GWMAG will derive its Judicial information from herein.

In regard to Federal Agencies, the majority of which are affiliated with the Executive Branch, a PAGE of STUF design will be presented which is applicable to agency and non agency alike at a Federal, State, and Local level. Back-drops will consist of agency shield, logos, headquarter building pictorials, historic and other interchangeable images which present a sense of nation. Left side console icons and right side graph icons will, of course, be present and be page/topic (agency, agency division, agency subdivision, etc.) specific. Superimposed on back-drop will be a large hollow pyramid with horizontal lines to indicate different hierarchical levels of agency as an overview. This pyramid will be located centrally and symmetrically, with each level containing writing and serving as an icon for access to more PAGES of STUF. Each level of pyramid will indicate the number of personnel, annual budget (with numerics displayed), number of offices and number of vehicles. (Example: Let's say that a specific agency has been organized on PAGES of STUF in such a way that it has six levels in the pyramid. The fifth level may read, “Seven offices in five States, eleven thousand two hundred employees, ninety-six million dollar annual operation.” This fifth level of pyramid then serves as an icon to access that specific information in more detail. The pyramid will occupy approximately three quarters of the page. In instances of complex agency division, inter-agency activity, non agency AOMB affiliation, and subcontractors, the large pyramid will be made smaller, with subsequent smaller separate pyramids (attached only by a line to proper level of central pyramid) serving as icons themselves. If it bears repeating, at this first agency PAGE of STUF, an Official Web Page Link icon will access the agency's main web page as will all left console icons be page specific. A PAGE of STUF which displays a specific remote office of an agency accessed through front page pyramid icon on fifth level will provide corresponding page/topic (file) specific live video feed from that remote office. All left console icons will be page/topic (file) specific, as will right graph icons as they display financial activity regarding that remote office. The initial first PAGE of STUF for each agency will display, on the pie graph in upper right, the agency's annual operating expense as a slice of the American pie (total U.S. budget for same year). Numerics will clearly display annual operating cost below pie. Slice of pie will serve as icon for financial overview of agency provided on separate page. Various agency divisions will display operating expense as a slice of agency pie (total agency operating expense for year). Page specific slice of pie icon will provide financial overview for that particular division. Linear graphs will display chronological operating expenses over twenty years. Further detailed financial data will be accessible by further research through financial PAGES of STUF. A second, far right, pie graph will display agency appropriation budget as a slice of annual operating expense. Linear graph provided on subsequent page will contrast these two. Other pie graphs will provide four categories, the three Branches and agencies, in order to display annual budget comparisons. Other pies will display total agency budget annually and compare (with slices) administrative costs, fleet maintenance, salaries, pensions, field workers, overhead, health care, transportation, advertising, appropriations, operating expense, and projected budget. This will serve as NETWORKCATALOGED sorting categories regarding financial aspects of each agency and to be so applicable as a page/topic file (specific) feature. Agency bio-demographies will provide, through trading cards file access, mission statement of agency, history of agency, constitutional reference to birth, assets, capital, resources, personnel (and amount), department heads, hierarchy, wages, benefits, pensions, number of divisions, departments (and offices), revenue and methods of revenue generation. As far as revenue generation is concerned for each agency that generates revenue apart from appropriated budget, PAGES of STUF will detail same by providing in depth financial breakdowns by office, method, investment account and re-investment. Examples of agency revenue generation would be State Park admission fees, fees and costs associated with civil infractions, misdemeanors, felonies (bail etc.). When multiple agencies have joined, in whole or in part, the secondary agency will display a pyramid with a line which attaches to the primary agency pyramid at appropriate level. Demographic text is also provided within secondary (tertiary etc.) pyramid as icons. Inter-agency mergers, agency/non agency mergers, Federal/State agency mergers will all provide pyramid size in vectorized proportionality, consistent with annual budgets, thus providing a visual budgetary comprehension in an abbreviated illustration. Agency subcontractors will all be presented in (proportionally) small pyramids connected to primary pyramid and serving as icons for access to specific SUBCONTRACTOR PAGES of STUF. MAPOFFICELOCATION will be provided for all agencies and non agencies as will all standard features which are page specific.

Regarding specific Federal Agencies, the following notes and examples provide further detail as to how PAGES of STUF are defined, sorted, filed and presented. Each cabinet level agency (Federal and State) will be provided a daily sixty-second allotment—an open forum—to be filed in HDATEFILES for broadband access to filed broadcast. Agency personnel will be asked to offer daily sixty-second filed broadcasts in HDATEFILES regarding specific aspect, division or office within agency. GWNN, GWMAG, and HDATEFILES will provide a format for agency personnel to educate the general public, in an ongoing series, regarding mission of the agency and agency field in general.

The U.S. Department of Justice will follow standard PAGES of STUF format, providing all standard features which are page specific; live video feed, MAPOFFICELOCATION, detailed crime statistics. A special feature will track Federal law enforcement dollars and resources as they filter down to State and Local law enforcement agencies. The War on Drugs has been classified as a non agency due to its tremendous resources and public awareness. This non agency titled The War on Drugs is located with the Department of Justice as AOMB protocol is adhered to. The War on Drugs PAGES of STUF will compare and contrast National and State expenditures on anti-drug public awareness campaigns (since inception) to actual or predicted social outcomes as they so relate to all categories of black market drug usage by K-12 and other demographic groups. The War on Drugs PAGES of STUF will provide expenditure breakdown, trends, patterns, advertising budgets (Federal and State dollars), agencies (Federal, State, and Local), expenditure verses incidence rates (graph), drug conviction statistics (National, State, and Local), International (and Columbia) expenditures. Sorting method will break down this war by drug, economics, agency (IFSL) and crime stats (IFSL). Demographics, specifically financial, will be sorted and presented in graph and linear formats identical for all law enforcement agencies (Federal, State, Local). Law enforcement is instituted as an Executive Agency at a Federal and often State level, yet locally, is in many cases an agency of the Judiciary, and will be so categorized within PAGES of STUF.

The National Aeronautics and Space Administration will follow standard PAGES of STUF format, providing all standard features which are page specific. Live video feed icon will not only display (multiple partitioned icons) access to administrative meetings and briefings, but will also provide live visual access to outer space through the multitude of governmental (host address) objects as described in Claim Twenty-three. Outer space images will be utilized in GWMAG. HDATEFILES will file daily broadcasts available to GWNN. NETWORKCATALOGED sorting methods will detail every vehicle ever launched by name or date, crew, cost, rocket type, number of orbits, launch location, orbit, manufacture, ground base of operations, purpose, life expectancy, and space junk. NETWORKCATALOGED files will provide access to footage (VDATE) from any mission or any aspect of any mission. Live video feed will provide icon access to live orbits at MAPPING 21, Sub 2 (and of course a live Hubble feed).

The Department of Defense will follow standard PAGES of STUF format, providing all standard features which are page specific. Front page pyramid icon will provide a brief illustration of asset allocation. Back-drops will provide historic, dramatic and interchangeable images. PAGES of STUF will provide detailed inventory breakdown for each of the four Branches (Army, Navy, Air Force, Marines). MAPOFFICELOCATION will display all units, divisions, headquarters and offices. Budgetary breakdown will be similar to that provided for any agency—personnel, salaries, pensions, equipment, assets, budgets, capital, offices, and a detailed review of the VA Hospital System and war colleges. Thorough inventory analysis to provide an overview of current U.S. capabilities—air sea and land (Nationally and Internationally), including National Guard and all Reservists of all Branches. Biographies provided for historic fighting divisions and, of course, persons—all found in Trading Cards.

The U.S. Treasury Department will follow standard PAGES of STUF format, providing all standard features which are page specific. Front page pyramid icon will be presented over back-drop of historic and related, interchangeable images providing a sense of National Currency. Agency bio-demography will include a detailed history and pictorial of U.S. Currency. HDATEFILES will provide updated filed broadcasts reviewing International markets, currencies, and trends (current and previous) utilizing linear and pie graphs. TREASURYFI will contain the actual budgetary breakdown of the Treasury Department. HDATEFILES will provide the daily filed sixty-second broadcast of Secretary as well as brief filed broadcasts regarding all aspects of agency, whether by agency personnel or not. The Federal Reserve is to be located in the SUBCONTRACTOR section.

The Federal Communications Commission, though technically a non agency, has been listed with the agencies as a division of the Department of the Interior, seeing as though wave forms are a National asset. All standard PAGES of STUF features are provided with an emphasis on wave forms and wave form distribution, wave form leases, wave form bands, wave form education, wave form allocation as well as the FCC's role in domestic internet protocols and regulations.

The Department of the Interior will have all standard features provided on PAGES of STUF with an emphasis on mineral resources (current and previous). Comprehensive lists of subcontractors (since 1607) will refer user to SUBCONTRACTOR ZONE for detailed analysis. Map mineral location will provide back-drop. NETWORKCATALOGED feature will provide direct DDWDR access to (and copies of) any and all contracts regarding mineral rights, purchases and agreements since 1607, including land purchases form Natives, Louisiana Purchase, Treaties of Paris, etc. Thus, a detailed land history is available and sorted by date, County, State, mineral, resource, contract, lease, lessee, lessor, corporation, involved parties, and price. Thus, this NETWORKCATALOGED feature applied within the Department of the Interior can be reviewed, along with the NETWORKCATALOGED toxi-geographic history (abstract) to obtain a detailed and comprehensive understanding of U.S. soil. Virtual tours of all domestic mines with detailed demographics and abstract of title, all agency specific added features.

The Department of State will have all standard features provided on PAGES of STUF. State Department personnel will be provided direct access to HOTTSPOTTS via a secured RDDWR link for broadband updates. MAPOFFICELOCATION will provide icon access to all embassies with, of course, live video feed option and Official Web Page Link. Detailed and simple (pie, linear) foreign appropriations breakdowns (current and previous) will correspond with International TREASURYFI data.

The Internal Revenue Service will have all standard features provided on PAGES of STUF. Agency personnel promoting innovative cutting edge concepts will be given preferential access to public forum through GWNN, GWMAG and HDATEFILES.

The Department of Energy will have all standard features provided on PAGES of STUF with emphasis on subcontractors and public utilities.

The Department of Health and Human Services will have all standard features provided on PAGES of STUF. The mental health industry in all its current (publicly funded) emphasis and high profile status has been categorized as a non agency with AOMB protocol assigning it to the Health Department Field.

All other Federal Agency PAGES of STUF will follow a similar model as that above described.

In regard to Federal non agencies, all standard features will be provided on PAGES of STUF. Three main categories exist, namely: Straight, Knotted, and Tangled. Back-drops for straight non agencies will provide a pseudo-historic, relative, and interchangeable image. A large pyramid will be superimposed over back-drop and provide icon access, file partitions, and NETWORKCATALOGED lists identical for that of agencies. Knotted non agencies will provide a knotted rope back-drop, utilizing all knot varieties interchangeably, as well as a specific number of knots to represent status of non agency. An interactive video will accompany each interchanged knot back-drop as an instructional video of two minutes as to the tying techniques of specific knot. The icon for this feature is titled Knot of the Week and will be presented atop back-drop. Knotted non agencies will display various titled icons as actual parts of knot(s). Tangled non agencies will display a back-drop consistent with things tangled (interchangeable) and directly proportional to severity of specific non agency's entanglement. When a straight non agency, knotted non agency, and/or a tangled non agency is visually displayed (according to AOMB protocol) in some affiliation to an agency (pyramid) display, the corresponding back-drop will accompany non agency. All three non agency categories will provide detailed bio-demographies, including history, mission, AOMB, origin source (enactment, non-enactment), budgetary source, employees, salaries, pensions, benefits, source of merged employees, operating expenses (daily, weekly, monthly, quarterly), and non budgetary revenue. These various sorting methods will serve as icons accessing other PAGES of STUF with corresponding and proportional back-drops. Examples of straight non agencies include the Nuclear Regulatory Commission, the National Security Administration, the Central Intelligence Agency, the Federal Trade Commission, the Securities and Exchange Commission, the National Endowment for the Arts, the National Library Service and the Federal Minerals Management Service, to name a few. Examples of knotted non agencies include Medicare, Medicaid, Social Security, and Lottery Commissions (State), to name a few. Examples of tangled non agencies include Family Independence Agency (FIA), Women and Infant Children (WIC), The War on Drugs, Mental Health, JHCO, The Nine Eleven Commission and College Research Studies, to name a few.

In regard to State Government, as State icon is selected on first page of actual network access, the next displayed page is that of a National Map vividly displaying all fifty States with well defined borders. Each State serves as an icon providing access to the first page (file) regarding selected State. Selected State will provide a page with back-drop of State geography outlined with superimposed American Flag theme. Other historic and other interchangeable back-drops that promote a sense of Statehood will be provided. Superimposed on back-drop will be a similar arrangement of first network page regarding State reverse tree aspect. These fourteen icons evenly spaced horizontally and vertically, consist of four rows. Top center quarter of page will display a small geographic State map icon, which when selected, provides an interchangeable, interactive, five minute State history lesson. Below that are three icons titled (from left to right) Legislative, Executive, Judicial. Third row displays six icons titled House, Senate, Agency, Non Agency, Agency, and Non Agency. The bottom row displays four icons titled Agency, Non Agency, Agency, Non Agency. Thin vertical lines connect corresponding entities in pyramid arrangement. All standard features will be provided on PAGES of STUF, including the thirty icons available by opening left upper console, the graph icon on upper right of page and the SHELLSEARCH at the top center of page. Left console icons and right graph icon will be page/topic (file) specific as with all PAGES of STUF. Shell search is not page/topic (file) specific as with all PAGES of STUF. In lower left corner is a small National Map icon which provides a go back feature. Within each agency and non agency icon, according to its branch attachment will be listed the current numeric amount on all PAGES of STUF. (Example: On the first PAGE of STUF for a given State under Executive level would be the icons Eighteen Agencies and Twenty-seven Non Agencies.) Provided along with the House and Senate icons—at both a State and Federal level—will be text and numbers indicating current amount of committees, subcommittees and conference committees. (Example: On the first PAGE of STUF for a given State under Legislative will be the icons House, Eighteen Committees, Thirty-two Subcommittees, Seventy-one Conference Committees.) The same applies to the Senate.

In regard to State Legislative, PAGES of STUF will provide identical format as that detailed for Federal legislative. State Legislative PAGES of STUF will have all standard features available and page/topic (file) specific, providing live video feed access to both Legislative bodies, as well as the other thirty features provided in left console.

In regard to State Executive, PAGES of STUF provides identical format as that detailed for Federal Executive. State Executive PAGES of STUF will have all standard features available and of course are page/topic (file) specific.

In regard to State Judicial, PAGES of STUF will provide identical format as that detailed for Federal Judicial. State Judicial PAGES of STUF will have all standard features available and are page/topic (file) specific. Each State, having unique court arrangements and jurisdictions, will adhere to the following arrangement of icons on first page of State Judicial (back-drop as described above). Five horizontal levels will evenly space icons. The top line will contain one central icon titled State Supreme Court. The second level will contain icons for each Appellate Court and one icon for Other Courts. The third level will contain icons for each (or provide numerical indication for amount) Circuit or County Court. The fourth level will provide icons for each (or provide numerical indication for amount) District or Misdemeanor Court. The fifth level will provide icons for each (or provide numerical indication for amount) City Court. Each icon will access related PAGES of STUF which will provide page/topic (file) specific application of the left console thirty icons as well as for the right upper graph icon. (Example: PAGES of STUF which happen to be within a City Judicial File will be able to access a live video feed of a particular court room, while pie and linear graphs provide financial information specific to the operations of that particular court.) Other Courts icon will access (display) a page listing various Probate, Friend of, Traffic, Drug Courts and others. State and Local Court bio-demographies will provide detailed analysis of not only the flow of Federal, State and Local Judicial dollars in both directions, but also Federal and State Legislative influence upon State and Local Judicial Liberty and revenue.

In regard to State Agencies, PAGES of STUF will provide identical format as that detailed for Federal Agencies. State Agency PAGES of STUF will have all standard features available and are page/topic (file) specific. Pie graphs on first page of each agency will contrast amount of Federal and State dollars into a particular agency with the pie representing the entire annual operating costs. Blank slices of pie would then indicate over budget and by how much. Linear graphs will so correspond with a chronological view as described herein.

State Department of Transportation agencies will provide all standard features available on PAGES of STUF. PAGES of STUF will provide five and ten year project projections with accompanying annual construction road map overlays. Each project (future and past) will provide start date, end date, budget, subcontractors, personnel, salaries, pensions, benefits, engineering firms, project manager and contact information. Thus, each specific project (future and past) will provide detailed (financial and otherwise) demographics. Road life expectancy forecasts provided for each project.

All other State Agency PAGES of STUF will follow a similar model as that above described.

Skoolz icon at a State level accesses Universities, while Skoolz icon at a local level accesses K-12 Public Education System. Both are referenced at various education agencies.

In regard to State Non Agencies, PAGES of STUF will provide all standard features as described throughout this claim. Several of a multitude include the Lottery Commission, the Insurance Commission, Family Independence Agency (FIA)*, Women and Infant Children (WIC)*, The War on Drugs*, Mental Health*, The Lottery Commission, and The Insurance Commission. (*A subcategory of agency called tangled non agency is a non agency that uses Federal, State and Local resources—personnel, offices, finances. Tangled non agencies are listed within this document as Federal non agencies, yet they adhere to AOMB protocol.)

In regard to Local and City Government, twenty main categories will be provided on second local page of STUF. All standard PAGES of STUF features will be provided. The first local page of STUF can be accessed from first actual network page by clicking on Local. Based upon a DRVS search, the user is then presented with a State map of his home State. This State map provides well defined county borders, which serve as icons. When a county is selected through icon, the second local page of STUF is displayed, providing a county map back-drop with well defined and color coded city boundaries. The twenty icons superimposed on this back-drop are evenly spaced, vertically and horizontally, in four rows. Two icons on the top row are titled County and City. Six icons on the second row are titled Legislative, Executive, Judicial, Legislative, Executive Judicial. Six icons on the third row repeat Agency, Non Agency three times. The fourth row is identical to the third. Vertical lines provide pyramid connections—an agency and a non agency for each of the three main branches for both city and county. Any of the ten city icons provides a county map only page (the same as for local page two) with city borders well defined and color coded. This map serves as an icon for city access. When city is selected, a city geographic map with U.S. Flag theme superimposed appears or other historic and interchangeable image presents as a back-drop. The ten city icons are then superimposed and are able to provide specific searches. Skoolz will be city specific as will live video feeds and the other thirty left console icons. Live school board (video) meetings will be accessed by live video feed while located within Skoolz ZONE. CRIMESTATS will be page specific as are Official Web Page Link and all others. City and county non agencies, (commissions, school boards, etc.), as well as county and city government proper, as well as county and city agencies will be NETWORKCATALOGED with similar sorting methods as detailed in Claim Three, Federal Legislative. Local geographic bio-demographies will include land mass, water mass, river length, natural resources, GDP, import and export at a county level, manufacturing, populations, and river biographies. Agencies (police, fire, EMS, public works, etc.) and millages will be accurately broken down on PAGES of STUF with inter-active millage teaching filed broadcasts. Pie graphs will portray county land ownership in various combinations of owned, rented, leased, private, corporate, public, and mineral rights. A county health insurance feature will accurately track county health insurance dollars into and out of the county. Another feature considers, analyzes, compares and tracks Federal dollars and resources into and out of the county. Constitution icon will access current County Charter or City Charter according to page/topic (file) and in English, by default.

In regard to Claim Number Four, live broadcast news (in the traditional sense), internet based news (pre-recorded broadcasts) and magazine news (in the traditional sense) will report entirely and solely upon government and governmental operation at a UN, International, Federal, State, and Local level—main branches, agency and non agency alike. Utilizing known and existing technological formats, forms, modes and methods of global communication in conjunction with pre-existing governmental databases and Freedom of Information Laws, this media market will provide three distinct forms and formats of governmental news coverage, namely: GOVWATCH News Network (GWNN) National Broadcast, the HDATEFILES Internet Broadcast and comprehensive, and GOVWATCH Magazine (GWMAG) publication and brief comprehensive summaries.

GWNN will provide live broadcast news twenty-four/six, entirely dedicated to and focused upon government and governmental operation. Designed to educate/instruct in all aspects, specifics are as follows:
1. GWNN will be presented in a one hour repetitive cycle with a fixed hourly schedule in which updates are introduced.
2. At the top of every our will be presented a one minute calendar for the day, week and month of primary political events (election dates, assembly dates scheduled) for UN, EU and International Governments. At fifteen past every hour will be presented a one minute calendar for the day, week, and month of primary political events (election dates, Judicial, Legislative, Executive, agency and non agency) rulings (and pending), legislation (and pending) executive schedule, agency briefings, hearings, non agency agendas, etc.) for the U.S. Federal Government. At half past every hour a State and/or local source will pick up the broadcast for a one minute State calendar providing State specific calendar to each U.S. State, with similar format to Federal calendar. At forty-five past every hour a one minute time slot will present a county specific calendar for and to each of the United State's three thousand one hundred and forty-one counties, similar to Federal and State calendar with election dates, college regent board meetings, school board meetings, county/city commission meetings, etc.—all government related.
3. At one minute past the hour, sixteen past the hour, thirty-one past the hour and forty-six past the hour, three minutes will be allotted for reading, review, commentary, and analysis of the various constitutions as defined herein by the word constitution. This will follow the calendar pattern as to international constitutions, UN and EU at the top of the hour (01), Federal U.S. Constitution at quarter past (16), then a break to local source at (31) for State specific constitution and at (46) for county and city charters
4. At forty-nine minutes past the hour will be one minute for the commercial of the hour slot.
5. At four minutes past the hour will be a one minute broadcast for HOTTSPOTTS.
6. At fifty past the hour will be ten minutes allotted for Scripture reading—an ongoing through the Bible reading with little or no commentary.
7. At five past the hour will be a one minute allotment for live video of the hour. Whatever may happen to be the most important one minute on the earth at that minute will receive a one minute allotment.
8. At six past each hour will be a one minute time allotment for the most recent national or international MVACET analysis coverage wherever it may be.
9. At seven past the hour will be a one minute astronomy section. Pure astronomy utilizing MPGVAC astronomical calendar, highlights of videos, pictures, orbits, physics data from experts, focused primarily on visual replay of available video and pictures.
10. At eight past the hour will be a one minutes allotment for economic and currency data for all Nations, emphasis on U.S., explanations, expert commentaries.
11. At nine past the hour will be a two minute allotment for environmental data—facts, MPGVAC, experts, toxicology updates Internationally (air, land, sea), epidemiologic/zoological anomalies.
12. At eleven past the hour will be a one minute allotment for a focus on a living American; one minute for those unheard who have a story to tell and wisdom to impart.
13. At twelve past the hour will be three minutes for updates, video, interviews from the UN, EU, and International assemblies.
14. At nineteen past the hour (Federally) and at thirty-four past the hour (State) will be a two minute allotment for coverage of the Executive Office at a Federal and State specific level, respectively.
15. At twenty-one past the hour (Federally) and at thirty-six past the hour (State) will be a two minute allotment for coverage of the Legislative Branch at a Federal and State specific level respectively.
16. At twenty-three past the hour (Federally) and at thirty-eight past the hour (State) will be a two minute allotment for coverage of the Judicial Branch at a Federal and State specific level, respectively.
17. At twenty-five past the hour (Federally) and at forty past the hour (State) will be a two minute allotment for coverage of agency (one minute) and non agency (one minute) at a Federal and State specific level, respectively.
18. At twenty-seven past the hour (Federally) and at forty-two past the hour (State) will be three minutes allotted for biographies (one minute), who are my elected officials (one minute), and government subcontractors (one minute) at a Federal and State specific level, respectively.

HDATEFILES provide an internet based brief comprehensive pre-recorded broadcast covering all main branches, agencies and non agencies at a UN, EU, International, Federal, State and Local level.

HDATEFILES will be filed retroactively since mans known advent on the earth.

HDATEFILES will be one minute in length, utilizing MPGVAC to prepare judicial reviews, judicial revenues, legislative summaries, executive summaries, agency daily activity and key events, non agency daily activity and key events—designed on an hourly rotation and updated daily. Designed to provide the time constrained individual a thoroughly comprehensive though brief update on all significant governmental activity on a global scale.

HDATEFILES are further explained in IFSLGOVWATCH Table of Definitions/Acronyms under UNFI example and HDATEFILES example.

GWMAG provides a weekly publication soft cover magazine of approximately fifty pages. An identical, simplistic, organized format presented in demographic 2 will be geared toward grocery store checkout lanes, 7-11's, party stores, quick stops and newsstands.

GWMAG is designed to provide coverage on the UN (first 5%), the EU (next 5%), International Governments (next 20%), the U.S. Federal Government (the next 45%), and State specific government (the last 25%).

GWMAG, though covering all significant events of government (main branches, agency and non agency) will focus a majority of the Federal (15-75%) and State (8.75%) sections on legislative review. Legislative review will provide abbreviated, comprehensive breakdown of Acts and Bills—primarily current yet a past and pending section also. These legislative reviews will also point out the path (various subcommittees and introductions) the contributors (legislators) and contributed section as well as the corresponding authors (staffers) and their contributed sections as well as biographies on legislator and staffer alike.

GWMAG will also provide a smaller judicial review section at a Federal (11.25%) and State (6.25%) level.

GWMAG will devote sections to executive activity at a Federal (9%) and State (5%) level. Agencies and non agencies alike will be provided sections at a Federal (4.5%) and State (2.5%) level. Portions of scripture and portions of the U.S. Constitution will provide ongoing studies on the front cover with a U.S. flag graphic background. The back cover will provide abbreviated, comprehensive, and simplistic budgetary data presented with graphs, charts and figures.

HOTTSPOTTS provides an internet based, one minute, filed broadcast on world events of that hour. Continually updated, extra abbreviated, thoroughly comprehensive, and simplistic, this feature draws from not only FOIA'd databases and private sources, but also from News Date files.

HOTTSPOTTS attempts to determine links to major world events at an IFSL level. Main back-drop presentation is of a world flat map (Mercator). Major hourly world events are highlighted on map with corresponding national flag, brief details, video bites, and contact information provided for each event.
Example 1: On a given day in the U.S. there may be a major industrial fire, two oil tanker explosions and two cops shot, all in various U.S. Geographies. On the same day internationally there may be a downed U.S. helicopter in Iraq with 8 dead and 12 wounded, four U.S. soldiers shot in Afghanistan and a tourist bus off a cliff in India, killing 40.

Example 2: Major oil pipeline explosion in Turkey two days ago (would take precedence over JonBenet Ramsey) which was unmentioned by American media markets, which largely provide cloned information from a central source. There are numerous examples of this ineptitude over the past fifteen years as the record will clearly show.

In regard to Claim Number Five, a custom designed internet based DRVS network search is made available by an icon titled “Who Are My Politicians?” This unique search provides custom files designed specifically to the user's account data, specifically zip code. Based on U.S. zip code connected to network access data, a file is accessed containing all elected politicians for that zip code, Federal, State and Local. This file presents two partitioned PAGES (files). The first page presents one page of organized, simplified, elected politicians' names, titles and orientation to governmental tree—Federal, State, Local, Legislative, Executive and Judicial. When a name (or name orientation) is selected a second file provides contact information, biographical sketches and a picture. Two icons are provided on this page—one titled print address opens a print file which will automatically print an envelope with name, address, and return address—as well as a formatted letterhead beginning with “From the desk of . . . ” A second icon provides a RVRS link to the elected politician's official web page address.

In regard to Claim Number Six, a custom designed internet based DRVS network search is made available by an icon titled Calendars. This unique search provides a custom designed calendar file (CALENDARFIPOLITICAL) which contains all election data at an IFSL level, yet geared for the U.S. citizen. Thus, upcoming scheduled Federal Legislative subcommittees, State appellate court dockets through to local school board meetings and county commission meetings are presented to the fellow in an organized, simplistic and updated manner.

Calendars icon, when accessed, opens a CALENDARFI (page) which lists all the available calendars for access and/or various SUPERIMPOSITION combinations. As the access to IFSLGOVWATCH is closed for the true Sabbath (and all commanded true festivals as recorded in the Pentateuch) according to time zone, hemisphere, and dusk, the true calendar will occupy the front page screen (representing a no access coded file).

Any and all ISLGOVWATCH tangible application requirements will operate according to the true calendar where as Gregorian will be presented to the general public in a default context.

In regard to Claim Number Seven, a DDWDR search, represented by an icon titled View Constitution, will initiate a NETWORKCATALOGED out of network search for selected constitution file(s) (CONSTITUTIONFI). View constitution icon will first initiate a network DRVS search which will automatically access (default) to a network copy of the original U.S. Constitution. This DRVS search is custom designed based on the user's zip code. Thus, the page (file) accessed containing the original U.S. Constitution presents options of U.S. Constitution, State Constitution, County Constitution (Charter), City Constitution (Charter) and lists all versions. A subsequent icon selection initiates the out of network DDWDR search for specific constitution. Three examples are provided in IFSLGOVWATCH Table of Definitions/Acronyms under CONSTITUTIONFI.

In regard to Claim Number Eight, four categories of biographies/demographies (with subcategories) will be provided as an internet based educational aspect (corresponding file partitions) of IFSLGOVWATCH. These bio-demographies consist of two constructions. One is lengthy (500 words plus) and written to a DEMOGRAPHICLEVEL 3, the second is comprehensively abbreviated (100 words or less) and written to a DEMOGRAPHICLEVEL 2. Available in various FFDR/FFDS and languages, and provided along with the affiliated topic at IFSLGOVWATCH, this claim is primarily concerned with the publication of all bio-demographies into trading cards. These IFSLGOVWATCH trading cards are prepared (utilizing the abbreviated text written to a DEMOGRAPHICLEVEL 2) in like manor as sports trading cards, providing pictures and other vital data. IFSLGOVWATCH trading cards are designed for the K-12 demographic groups. All bio-demographies, of both constructions, are to be of excellent quality.

Bio-demography categories include geographical, political, corporate and personal. These categories are so applied at a UN, EU, International, Federal, State, and Local level in both constructions, in various languages, and DOWNLOADABLE.

Geographical bio-demographies at an International level will be accompanied by a national map and national flag and include topics such as U.S. involvement (financially, historically and otherwise), natural resource assets, form of government, history of Christianity and Christian persecution and other geo-historic data. Bio-demographies at a State level will be accompanied by a State geographic outline with U.S. flag theme superimposed and include topics such as natural resources, assets, history, and other standard geographic data. Bio-demographies at a Local level will include county and city geographic outline with a U.S. Flag theme superimposed (international, cities, counties, provinces, etc. will superimpose national flag theme on geographic outline). These local bio-demographies will include topics such as natural resources, assets, history and other standard geo-historic data. IFSLGOVWATCH trading cards will present a three dimensional topographic physical map with rivers and water bodies emphasized (superimposed) as the picture for State and Local trading cards, whereas flag theme map is internet based.

Political bio-demographies will present standard governmental demographic data (history, budgetary, contact information, etc.) and presented at a UN, EU, International, Federal, State and Local level, including main branches, agency and non agency alike.

Corporate biographies will provide historic, economic, geographic and contact data for those corporations deemed subcontractors. Also provided will be AOMB (and contact) data.

Personal biographies will include history, voting record, salary, subcommittees, conflicts of interest, sponsored legislation, staff members, office operating expense, campaigns, campaign funds, all previous campaign ads (NETWORKCATALOGED), stock portfolio, a picture and religion (if known member of secret society, corresponding insignia displayed).

Non Masons in historic U.S. is a partitioned file of personal biographies and spotlights historic U.S. figures that have not been members of secret societies (1607—present) providing biographies for same.

In regard to Claim Number Nine, this internet based search combines, compares, and contrasts data of five main categories (source, meteorological, toxin, past, live graphic). Source and meteorological categories utilize live input and/or frequent (15 minute) updates. Toxin category derives its input data from comprehensive, detailed, alphabetized list type definitions. Toxin (each) definitions include name, molecular structure, molecular weight (mass), source (chemical, industrial, process), epidemiological studies (current and earliest published on toxin), zoological/avian/marine epidemiological studies (current and earliest published on toxin). Past category provides detailed analysis of core samples across the globe in regard to toxins on list. Core samples of no less than one every one hundred square miles for large land and water masses, and prolifically for small land and water masses, current flows, rivers, tributaries, deltas and man made outlets (storms and sewers). This toxi-geographic data is further detailed by the various subcategories (SUPERIMPOSITION), chronology and origin of toxins in MAPFI (MAPPING 27). Live graphic category presents excellent quality animation of physical map, air and water currents, in a three dimensional orientation, which serves as a visual (function program) for the other four categories in their various combinations.

Environment Watch will produce toxicological biographies for all streams, rivers, tributaries, lakes and regional land masses in detailed text format, conjoined with live graphic animation based upon other category data (source, meteorological, toxin, and past) at an IFSL level.

Environment Watch considers the following data (file partitions) for its estimates and projections. Source/emission mode (air—altitude; water—public storm, public sewer, private; ground), source/emission output (toxin(s) in emission—type and amount; temperature of emission solution), toxin (molecular weights(s) of toxin(s), thermal state(s) table), meteorological (air current—speed and direction; water current—speed and direction; temperature of medium surrounding emission medium solution—air, water, land; soil—type and filtration rates; pressure—air and water).

Environment Watch combines, compares, and contrasts the applicable data in above paragraph to produce the following estimates (ESTM) and projections (PJ):

1. Cooling rates of emission solution (ESTM)

2. Cooling rates of toxin(s) in emission solution (ESTM)

3. Diffusion rates of emission solution (ESTM)

4. Diffusion rates of toxin(s) in emission solution (ESTM)

5. Wind/water drift of toxin(s) (ESTM)

6. Landfall location of toxin(s) (PJ)

7. Rate of land fall toxin(s) (PJ)

8. Water/sediment fall location of toxin(s) (PJ)

9. Water/sediment fall rate of toxin(s) (PJ)

10. Soil penetration rate of toxin(s) (PJ)

11. Soil penetration depth of toxin(s) (PJ).

Environment Watch utilizes the above estimates and projections as a function of live graphic animation to produce accurate portrayals of current toxic emissions (color coded) at a county-by-county level. An example of this is found in IFSLGOVWATCH provisional patent, page fifteen.

Environmental Watch will present live graphic (and text) portrayals at an IFSL level and utilize one of the three following methods of data access:

First, by providing six thousand seven hundred and sixty-eight network ROOTFILES—two for each Nation, U.S. State and U.S. County (one for NETWORKCATALOGED out of network access and one for catalogued network access to edited files). A DDWR search provides a direct link to host address (International, Federal, State, and Local Government owned air and water quality monitors) and is dependent on FOIA cooperation for tangible application aspect.

Second, by providing six thousand seven-hundred and sixty-eight network ROOTFILES—two for each Nation, U.S. State and U.S. County (one for out of network access (input) via a RDDWR link and one for CATALOGEDNETWORK access to edited files). This method requires private individuals to provide data for tangible application aspect.

Third, by providing various combinations of the above two, tangible application aspect will commence.

Environment Watch will provide a file partition which accurately produces retroactively—annual toxin (amount and type) files, at an IFSL level, based on core/sediment data. This post dated annual information is then displayed in list form next to personnel employed by the various environmental quality/protection agencies of government for that year(s) at an IFSL level.

Environment Watch will also provide two blog sites at a county level. One will be dedicated to local landfill and waste management. One will be dedicated to soliciting local plans for a tree planting campaign. This tree planting campaign blog will focus on fine hardwoods and white pine and will provide for graphic design plan postings.

In regard to Claim Number Ten, all subcontracted entities of government—at a UN, International, Federal, State, and Local Level (main branches, agencies, and non agencies)—will be accessible, along with other pertinent information through internet based network and out of network searches.

Sub Watch provides six thousand seven hundred and seventy two network ROOTFILES (UN (2), International (388), State (50), Local (3141)). One file for NETWORKCATALOGED out of network access (with three main partitions) and one file for CATALOGEDNETWORK access to edited files containing PAGES of STUF.

Sub Watch files, provided for every subcontractor, will provide NETWORKCATALOGED (and CATALOGEDNETWORK) methods of file organization according to County, State, Nation, UN, alphabetic, industry classification, goods, services, leases, easements, subsidies, land grants, pollution credit and tax break arrangements, AOMB, legislation, contractual, financial, judicial—court and case.

The first main partition of the NETWORKCATALOGED root file will provide NETWORKCATALOGED out of network access to any and all pertinent legislation (creating, requiring, authorizing, permitting, enhancing, or otherwise) as well as any and all subsequent judicial reinforcement thereof as it so regards each specific subcontractor.

The second main partition of the NETWORKCATALOGED root file will provide NETWORKCATALOGED out of network access to any and all pertinent contractual agreements (goods, service, leases, easements, subsidies, land grants, pollution credits, tax break arrangements—land, revenue or otherwise) as it so regards each specific subcontractor.

The third main partition of the NETWORKCATALOGED root file will provide NETWORKCATALOGED out of network access to any and all pertinent financial information (tax returns or otherwise) as it so regards each specific subcontractor.

Sub Watch will provide out of network access via a DDWDR search.

CATALOGEDNETWORK access to edited files containing PAGES of STUF will provide a backdrop picture of corporate headquarters, a pie graph in upper right corner of page listing and displaying annual governmental revenue (gross), a linear graph in upper right corner of page, providing a chronological view of pie graph data, MAPOFFICELOCATION feature, contact information, an icon providing a direct link to official web site via an RVRS search, campaign contributions broken down by annum, amount, and benefactor as well as bio-demographies per subcontractor entity, leading subcontractor personnel (with brief video interviews), registered lobbyist (with brief video interviews and contact information) and detailed environmental records.

Some examples of subcontractors include public utilities, highway/road builders, pharmaceutical industry, Microsoft, petroleum industry, auto manufacturers, media (leasing national wave forms), printers, publishers, investigative boards, legal firms, consulting firms, research institutes, think tanks, defense contractors, and the insurance industry (to name a few).

In regard to Claim Number Eleven, this internet based, stand alone news magazine will provide DEMOGRAPHICLEVEL 4 analysis to physicians and researchers, DEMOGRAPHICLEVEL 3 analysis to healthcare workers, and DEMOGRAPHICLEVEL 2 to the general public. From within the network, detailed pathogenic lists can be searched and subsequent links to out of network databases through RVRS, DDWR, DDWDR, VDATE, CDATE, and ADATE as well as network searches of edited files.

This epidemiological data will include biological, chemical and radioactive data at an IFSL level which is acquired, edited and published.

By providing a secure website, users will be able to access a variety of anonymous forms, each designed to ask specific questions and provide specific values so as to determine regional trends (an example would be specific toxicology results, metallurgic panels, dioxin levels, contrasted to cancer, autism, asthma incidence, etc.). Thus, regional toxicology patterns can be established and this data edited then published and contrasted to environmental toxins released by regional industry found in a subcontractors search.

Epidemiology Weekly will fill the current vacuum in this arena of which I will outline by touching on seven specific examples (cited in a previous writing Apr. 7, 2006) to help further define this Dependent Claim.
1. Working in health care I found there to be a significant lack of source data (not to mention the editing of that data) provided to healthcare workers, first responders and the public in general. A Rubella memo provided brief precautionary data from a local health department referencing one International/Local occurrence and requesting all incidences be reported back to local health department. The emphasis on solicitation of feedback seemed to far outweigh the dissemination of information to healthcare workers. Epidemiology Weekly would provide detailed editing, as well as retroactive and background data to healthcare workers at primarily a DEMOGRAPHICLEVEL 3, while publishing same information available to Epidemiology Weekly at DEMOGRAPHICLEVEL 4 and the general public at DEMOGRAPHICLEVEL 2.
2. Logging on to www.worriedaboutmemoryloss.com (whose billboards blanket the State of Michigan), I found there to be a significant void in the website's output intelligence, with emphasis again on input intelligence. Epidemiology Weekly could fill this void by providing confidential input access to all citizens through Epidemiology Weekly Publications. Outbreaks could then be tracked at a county level and thus edit and correlate that edited to various dates and times throughout urban, suburban and rural populations. Once edited, PAGES of STUF would be made available in Epidemiology Weekly Publications to all demographic levels.
3. Contacting a local health department, there was found to be no knowledge, contacts, or resources regarding memory loss data. Neither was there available any comprehensive lab (blood work) panels of any sort including metallurgic (except pediatric lead). The emphasis seemed to be on family planning and STD treatment. Epidemiology Weekly will work with local health departments, private providers and private citizens (via the NBC home test kit FFDI), EDIT and PUBLISH toxicological blood anomalies, metallurgic blood anomalies (both considered chemical), standard blood panel anomalies, behavioral/cognitive/psychological anomalies, biological blood borne anomalies, radioactive blood borne anomalies, as well as STD incidence. These results, anomalic or otherwise, will be published at various demographic levels and available to citizens from Epidemiology Weekly Publications.
4. The autumn of 2005 presented itself with an anomalically high incidence of pediatric upper respiratory infections throughout a certain county. A (time and resource challenged) inquiry uncovered a consensus at a certain hospital of a “spike” in upper respiratory/croup incidences for several weeks. Along with this particular anomaly was found a significant void of epidemiological information available from Local, State, and Federal sources (needless to mention vacuous local media coverage) as to the precise strain(s) identified of any particular viral, bacterial or mycoplasmic pathogen. Epidemiology Weekly would provide NETWORKCATALOGED access to out of network databases regarding strains of various pathogens as well as CATALOGEDNETWORK pathogenic histories.
5. The winter of 1997-1998 presented a unique pathogen throughout a multiple county region. This pathogen provided healthy adults with, generally speaking, significant pharyngeal abscess (five days plus) with hyperpyrexia (four days plus). Inquiries as to specific pathogenic data proved futile. Unaffected by broad spectrum antibiotics, the level of specificity obtainable regarding this occurrence remains as “pus-sickle.” Epidemiology Weekly would acquire, EDIT, and PUBLISH this post dated material (from out of network databases) and provide same through Epidemiology Weekly Publications.
6. The mid 1990's presented a family member with a pathogen causing an acute onset coma. Soon airlifted to a facility with known CDC affiliation, a lengthy recovery ensued. Numerous attempts made to determine the precise pathogen identified proved futile. Sepsis remains the level of specificity provided. Epidemiology Weekly would acquire, EDIT, and PUBLISH this data, providing a precise identification through Epidemiology Weekly and available at DEMOGRAPHICLEVEL 1-4 in various languages.
7. Finally, Epidemiology Weekly will provide detailed daily updates, follow-ups and map graphics regarding the Avian Flu. In depth facts, source data, background information, personnel, agencies and budgets will provide the general public with solid, ongoing information as opposed to the current haphazard hit and miss reporting.

In regard to Claim Number Twelve, three thousand three hundred and eighty-three network ROOTFILES will be provided for out of network access to live streaming audio and live streaming video (internet based) at an IFSL level.

NETWORKCATALOGED lists will provide (an icon for) a direct link to specific out of network host (address) providing streaming video and/or audio via DDWR access.

This aspect of IFSLGOVWATCH is called streaming audio central and provides, as the name implies, a centralized NETWORKCATALOGED database of all streaming audio and all streaming video at an International, Federal, State and Local level.

This convenient “Central Station” allows the user to follow and compare various network newscasts as they relate to governmental affairs as well as providing entertainment value.

Streaming audio central is geared to provide local (county) audio and video broadcasts to local (county) citizens and thus so organizes its ROOTFILES (3141). Other network ROOTFILES provide State (50) and International (192) catalogs.

Streaming audio central also provides (internet) access to (via identical translator technology) the less common bands (long wave, short wave, citizens, public safety) with sophisticated scanning.

Other NETWORKCATALOGED methods of file organization (beside geographic) include—by alphabetic (proper initial name), frequency, band, and owner.

Tangible application aspect is directly related to availability (known, FOIA'd or otherwise) of specific (DDWR) host address.

In regard to Claim Number Thirteen, six thousand seven hundred and sixty-eight network ROOTFILES will be provided at an International (384), Federal (2), State (100), and Local (6282) level. One file for NETWORKCATALOGED access to out of network related databases and one file for CATALOGEDNETWORK access to edited files containing PAGES of STUF. A DDWDR search is utilized for out of network search access.

Motor Vehicle Accident Causative Effect Training (MVACET) collects, organizes, compares, contrasts, and collates data regarding motor vehicle accidents and is internet based. This is done by providing three main categories (with various subcategories and divisions), namely: causative, effect, and training.

The effect category of MVACET has three subcategories, namely: variables, impact, and kinetics.

There are thirty-four divisions of the variable subcategory as follows: speed, road condition, road class, time of day, traffic condition, specific road, specific stretch of road, lane, number of passengers, age of passengers, gender of passengers, sexual orientation of passengers, race of passengers, type of vehicle, gross vehicle weight, color of vehicle, window condition, mirror type (side view fish eye), mirror skill, tire type, tire condition, break condition, alcohol (level), marijuana level, central nervous system stimulant (level), central nervous system depressant (level), hallucinogen, impaired other, distraction type, age of driver, gender of driver, race of driver, sexual orientation of driver, and number of vehicles involved.

There are three divisions of the impact subcategory as follows: object(s) impacted, location of impact(s), number of impact(s).

There are four divisions of the kinetics subcategory as follows: stop, swerve (primary—angle and distance, secondary—angle and distance, tertiary—angle and distance), deflection (primary distance, secondary distance, tertiary distance), and roll (side, direction, and number starting at one quarter).

The above listed multidimensional factors (effect) are then categorized in numbered (or named) linear lists called effect lists.

The cause category of MVACET requires scene personnel to identify the precise, original, actual causative factor or factors of the motor vehicle accident. These yet to be determined causative factors participate in the formation of comprehensive linear lists called causative lists.

The training category of MVACET is based upon collection, comparison, contrast, and collation of causative lists and effect lists—one to another. This data calculates/generates comprehensive (and third) linear lists called training lists. It is these training lists which will not only identify numerous trends, but will also serve as a springboard for public awareness and teaching campaigns (provided in all FFDR/FFDS via FT) one of which will be a sixty second nightly broadcast (on GWNN or other) by the county sheriff or his MVACET designee regarding “Training” on that day's significant motor vehicle accidents in the county.

In regard to Claim Number Fourteen, six thousand six hundred and sixty-eight network ROOTFILES will be provided at an International (386) and U.S. Local (6282) level; one for NETWORKCATALOGED out of network access and one for CATALOGEDNETWORK access to edited files containing PAGES of STUF.

This internet based network host accesses out of network filed video (via a DDWDR) which provides virtual tours of every city on planet earth. A network file partition provides access to all thirty-six mapping category files (and SUPERIMPOSITION) for comparison to street of virtual tour—alone or as a one eighth size upper left corner screen overlay of video.

This claim provides access to live video traffic cameras throughout above mentioned cities with CATALOGEDNETWORK lists and a DDWR search utilizing a file partition.

This claim is called “See the World for Free” and provides for three other NETWORKCATALOGED file partitions as follows: one for RVRS icon access to the specific city chamber of commerce official website, one for RVRS icon access to the specific city government official website and one for a blog site called Graffiti Watch which, as the name implies, allows citizens (in each city on earth) to post updates in MPGVAC regarding local graffiti patterns.

In regard to Claim Number Fifteen, a new and improved, useful method (tool) of access, editing, and presentation of geo-governmental affairs is based upon a solid governmental organization system consisting of twenty main categories and their various subcategories, presented in outline form for the arrangement of database files according to above mentioned organizational system. Further definitions and explanations are located in Table of Terms/Acronyms under 1234ABCDCOUNTYSTATUS. The 20 main subcategories are as follows:
I. MEDICAL FACILITIES (MF). Those buildings and structures identified as being available (currently or readily) to be occupied by the sick and/or injured as well as by medical personnel and medical equipment. Each facility within each of the seven facility subcategories (MF1 through MF7) is to provide status reports regarding the number of occupied and unoccupied beds for each of the eleven listed specialties every twelve hours (minimum) with projections (PJ). Each facility (MF1 through MF7) requires two guarded back-up power supplies with a thirty day fuel supply (minimum) as well as a back-up heat source for thirty days (minimum). One designated spokesman over all of the seven facility subcategories (MF1 through MF7) will also be in charge of entering status report data for each facility subcategory (every twelve hours). A spokesman will also be provided with back-up communications (CMBU). Criteria (to be developed by disaster planning experts) will establish minimum guidelines required in order for any facility (MF1 through MF7) to be upgraded to a primary facility (MF1) regarding specific number of beds, personnel, equipment, communications, etc. Mobile, back-up, mass sanitation (see category eighteen SAN1 through SAN7) devices available for each facility within each of the seven facility subcategories (MF1 through MF7) with demand projections (PJ). Each facility to be deemed free of any pre-existing internal hazards (collapse, fire, explosion). Once certified, utilize specialized guard detail for each facility within each of the seven facility subcategories (MF1 through MF7). Intensive care units located with corresponding disciplines.
   A. Primary Facility Status (MF1). Primary facilities to include all currently active hospitals (Level I, II, III, IV).
      1. Beds Available Per Facility (BAPF)
         a) Burn Beds (BUB)
         b) Trauma Beds (TRB)
         c) Operating Rooms (OPRB)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO)
         h) Radiation (RAD)
         i) Biological (BIO)
         j) Chemical (CHM)
         k) Pediatric (PED)
         l) Emergency-General-Triage (ER)
   B. Secondary Facility Status (MF2). Secondary facilities to include active, bedded, staffed buildings such as nursing homes and doctors' offices.
      1. Beds Available Per Facility (BAPF)
         a) Burn Beds (BUB)
         b) Trauma Beds (TRB)
         c) Operating Rooms (OPRB)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO)
         h) Radiation (RAD)
         i) Biological (BIO)
         j) Chemical (CHM)
         k) Pediatric (PED)
         l) Emergency-General-Triage (ER)
   C. Tertiary Facility Status (MF3). Tertiary facilities comprise vacant, bedded facilities such as vacant hospitals, vacant nursing homes, and vacant annexes able to be rapidly occupied, staffed (MP) and equipped (MEQ).
      1. Beds Available Per Facility (BAPF)
         a) Burn Beds (BUB)
         b) Trauma Beds (TRB)
         c) Operating Rooms (OPRB)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO)
         h) Radiation (RAD)
         i) Biological (BIO)
         j) Chemical (CHM)
         k) Pediatric (PED)
         l) Emergency-General-Triage (ER)
   D. Quaternary Facility Status (MF4). Quaternary facilities to comprise multiple possible staging areas able to be rapidly occupied, staffed (MP), equipped (MEQ), bedded and supplied with heat (category 17), electricity (category 15), food (category 7), water (category 16) and sanitation (category 18), such as warehouses, churches, abandoned buildings and fall-out shelters (FOSF).
      1. Beds Available Per Facility (BAPF)
         a) Burn Beds (BUB)
         b) Trauma Beds (TRB)
         c) Operating Rooms (OPRB)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO)
         h) Radiation (RAD)
         i) Biological (BIO)
         j) Chemical (CHM)
         k) Pediatric (PED)
         l) Emergency-General-Triage (ER)
   E. Fifth Level Facilities (MF5). Fifth level facilities comprise beds and bath tubs at private residences of which the public will be encouraged to input status through secured (RDDWR³) computer (Firewall) access or other FFDI¹ via FT².
      1. Beds Available Per Facility (BAPF)
         a) Burn Beds (BUB)
         b) Trauma Beds (TRB)
         c) Operating Rooms (OPRB)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO)
         h) Radiation (RAD)
         i) Biological (BIO)
         j) Chemical (CHM)
         k) Pediatric (PED)
         l) Emergency-General-Triage (ER)
   F. Sixth Level Facilities (MF6). Sixth level facilities include mobile response entities such as military agencies, federal agencies, international agencies, Red Cross and others which will be required to input capabilities (RDDWR³) or other FDDI¹ via FT² consistent with the various subcategories prior to response.
   G. Seventh Level Facilities (MF7). Seventh level facilities include the above six levels of medical facilities (MF1 through MF) as applied to, and located at, any and all fixed or mobile incarceration facilities (CRIMJUS1 through CRIMJUS3) located within the county.
      1. Beds Available Per Facility (BAPF)
         a) Burn Beds (BUB)
         b) Trauma Beds (TRB)
         c) Operating Rooms (OPRB)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO)
         h) Radiation (RAD)
         i) Biological (BIO)
         j) Chemical (CHM)
         k) Pediatric (PED)
         l) Emergency-General-Triage (ER)
II. MEDICAL PERSONNEL (MP). Medical personnel refers to those human beings having varying degrees of medical training, licensure, certification or authorization currently residing within the county (on-duty, off-duty, or not employed) as well as those residing out of county indicating availability for in county emergency response. All personnel participating (MP1 through MP3) must log in (RDDWR³) every twelve hours as to their status for the upcoming twelve hours. Two colurns will be displayed for each category of medical personnel participating (MP1 through MP3). One will identify personnel by assignment to specific facilities (MPF1 through MPF6). The second column will identify total available medical personnel (in county only) according to medical personnel categories (MP1 through MP3).
   A. Primary Medical Personnel Status (MP1). Primary medical personnel refers to those people having varying degrees of medical training, licensure, certification or authorization currently working (duty) within the county (regardless of residence) required to enter (input) expected facility location (F) for upcoming twelve hours.
      1. Physicians (PHYS) and Specialties
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Practitioners (GP)
         g) Isolation (ISO) assignment availability to be so indicated after specialty designation
         h) Radiation (RAD) assignment availability to be so indicated after specialty designation
         i) Biological (BIO) assignment availability to be so indicated after specialty designation
         j) Chemical (CHM) assignment availability to be so indicated after specialty designation
         k) Pediatric (PED)
         l) Emergency Room (ER)
         m) Anesthesiologists (ANEST)
      2. Nurses (NUR) and specialties. To include RN and LPN with specialized training and experience corresponding to the various listed disciplines.
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Certified Registered Nurse Anesthetists (CRNA)
      3. Residents (RESD). To include medical school graduates assigned to a facility receiving further specialized training and to correspond to the various listed disciplines.
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Practitioners (GP)
         g) Isolation (ISO) assignment availability to be so indicated after specialty designation
         h) Radiation (RAD) assignment availability to be so indicated after specialty designation
         i) Biological (BIO) assignment availability to be so indicated after specialty designation
         j) Chemical (CHM) assignment availability to be so indicated after specialty designation
         k) Pediatric (PED)
         l) Emergency Room (ER)
         m) Anesthesiology (ANEST)
      4. Emergency Medical Technicians (EMT). To include licensed paramedics (EMTP) specialists (EMTS), basics (EMTB), medical first responders (EMTMFR) within the county and further designated by any additional licensure, certification or authorization to function within listed disciplines otherwise default to emergency room (ER)
         a) Burns (BU)
         b) Trauma (TR)
         c) Surgery (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Rapid Sequence Intubation (RSI)
      5. General Technicians (GENTEC). To include those persons with varying degrees of medical training whether licensed, certified, or authorized to function at various levels within the below listed disciplines. (Certified nurse assistants, phlebotomists, respiratory techs, police, fire, private security, military medical training, etc.)
         a) Burns (BU)
         b) Trauma (TR)
         c) Surgery (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Respiratory Techs (CRT)
   B. Secondary Medical personnel Status (MP2). Secondary medical personnel refers to the identical medical personnel subcategories listed under primary medical personnel (MP1), yet applied to off-duty personnel and/or not employed personnel within the county actively participating in 1234ABCDCOUNTYSTATUS.
      1. Physicians (PHYS) and Specialties
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Practitioners (GP)
         g) Isolation (ISO) assignment availability to be so indicated after specialty designation
         h) Radiation (RAD) assignment availability to be so indicated after specialty designation
         i) Biological (BIO) assignment availability to be so indicated after specialty designation
         j) Chemical (CHM) assignment availability to be so indicated after specialty designation
         k) Pediatric (PED)
         l) Emergency Room (ER)
         m) Anesthesiologists (ANEST)
      2. Nurses (NUR) and specialties to include RN and LPN with specialized training and experience corresponding to the various listed disciplines.
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Certified Registered Nurse Anesthetists (CRNA)
      3. Residents (RESD). To include medical school graduates assigned to a facility receiving further specialized training and to correspond to the various listed disciplines.
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Practitioners (GP)
         g) Isolation (ISO) assignment availability to be so indicated after specialty designation
         h) Radiation (RAD) assignment availability to be so indicated after specialty designation
         i) Biological (BIO) assignment availability to be so indicated after specialty designation
         j) Chemical (CHM) assignment availability to be so indicated after specialty designation
         k) Pediatric (PED)
         l) Emergency Room (ER)
         m) Anesthesiology (ANEST)
      4. Emergency Medical Technicians (EMT). To include licensed paramedics (EMTP) specialists (EMTS), basics (EMTB), medical first responders (EMTMFR) within the county and further designated by any additional licensure, certification or authorization to function within listed disciplines otherwise default to emergency room (ER)
         a) Burns (BU)
         b) Trauma (TR)
         c) Surgery (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Rapid Sequence Intubation (RSI)
      5. General Technicians (GENTEC). To include those persons with varying degrees of medical training whether licensed, certified, or authorized to function at various levels within the below listed disciplines. (Certified nurse assistants, phlebotomists, respiratory techs, police, fire, private security, military medical training, etc.)
         a) Burns (BU)
         b) Trauma (TR)
         c) Surgery (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Respiratory Techs (CRT)
   C. Tertiary Medical Personnel Status (MP3). Tertiary medical personnel refers to the identical medical personnel subcategories listed under primary and secondary medical personnel (MP1, MP2), yet applied to those residing out of county available for in county emergency response, actively participating in 1234ABCDCOUNTYSTATUS.
      1. Physicians (PHYS) and Specialties
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Practitioners (GP)
         g) Isolation (ISO) assignment availability to be so indicated after specialty designation
         h) Radiation (RAD) assignment availability to be so indicated after specialty designation
         i) Biological (BIO) assignment availability to be so indicated after specialty designation
         j) Chemical (CHM) assignment availability to be so indicated after specialty designation
         k) Pediatric (PED)
         l) Emergency Room (ER)
         m) Anesthesiologists (ANEST)
      2. Nurses (NUR) and specialties to include RN and LPN with specialized training and experience corresponding to the various listed disciplines.
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Certified Registered Nurse Anesthetists (CRNA)
      3. Residents (RESD). To include medical school graduates assigned to a facility receiving further specialized training and to correspond to the various listed disciplines.
         a) Burns (BU)
         b) Trauma (TR)
         c) Surgeons (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Practitioners (GP)
         g) Isolation (ISO) assignment availability to be so indicated after specialty designation
         h) Radiation (RAD) assignment availability to be so indicated after specialty designation
         i) Biological (BIO) assignment availability to be so indicated after specialty designation
         j) Chemical (CHM) assignment availability to be so indicated after specialty designation
         k) Pediatric (PED)
         l) Emergency Room (ER)
         m) Anesthesiology (ANEST)
      4. Emergency Medical Technicians (EMT). To include licensed paramedics (EMTP) specialists (EMTS), basics (EMTB), medical first responders (EMTMFR) within the county and further designated by any additional licensure, certification or authorization to function within listed disciplines otherwise default to emergency room (ER)
         a) Burns (BU)
         b) Trauma (TR)
         c) Surgery (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Rapid Sequence Intubations (RSI)
      5. General Technicians (GENTEC). To include those persons with varying degrees of medical training whether licensed, certified, or authorized to fluction at various levels within the below listed disciplines. (Certified nurse assistants, phlebotomists, respiratory techs, police, fire, private security, military medical training, etc.)
         a) Burns (BU)
         b) Trauma (TR)
         c) Surgery (SUR)
            (1) Trauma (TR)
            (2) Neurological (NRO)
            (3) Orthopedic (ORT)
            (4) Eye, Ear, Nose, and Throat (EEN)
            (5) Cardiac (CAR)
            (6) General (GEN)
         d) Cardiac (CAR)
         e) Neurological (NRO)
         f) General Med-Surg (GEMS)
         g) Isolation (ISO) assignment availability
         h) Radiation (RAD) assignment availability
         i) Biological (BIO) assignment availability
         j) Chemical (CHM) assignment availability
         k) Pediatric (PED)
         l) Emergency Room (ER)
         m) Respiratory Techs (CRT)
III. MEDICAL TRANSPORTATION (MT). Medical transportation refers to those vehicles available (currently or readily) for the transport of the sick and/or injured within the county boundaries and actively participating in 1234ABCDCOUNTYSTATUS.
   A. Primary Medical Transportation (MT1). Those vehicles currently operating (and staffed) in the public safety sector within the county. Amount and EMP status to be specified.
      1. Ambulances (AMB). Inclusive of public and private.
         a) Advanced Life Support (ALS)
         b) Basic Life Support (BLS)
         c) Wheel chair vans, cargo vans, busses, fire department vans and busses, other non ambulance vehicles (OTV)
      2. Police (POL)
         a) Squad Cars (SQC)
         b) Vans, busses, and other (OTV)
      3. Corrections (CORR)
         a) Transport Vans (TRV)
         b) Transport Busses (TRB)
      4. Animal Control (ANMCTR)
         a) Transport Vans and Trucks (TRV)
         b) Transport (converted) Busses (TRB)
      5. Morgue (MRG) Body Transport
         a) Hearses (HRS)
         b) Trucks, vans, busses, other (OTV)
   B. Secondary Medical Transportation (MT2). Those vehicles not currently operating (but functional), due solely to personnel shortage in the public safety sector within the county.
      1. Ambulances (AMB). Inclusive of public and private
         a) Advanced Life Support (ALS)
         b) Basic Life Support (BLS)
         c) Wheelchair vans, cargo vans, busses, fire department vans and busses, other non-ambulance vehicles (OTV)
      2. Police (POL)
         a) Squad Cars (SQC)
      b) Vans, busses, and other (OTV)
      3. Corrections (CORR)
         a) Transport Vans (TRV)
         b) Transport Busses (TRB)
      4. Animal Control (ANMCTR)
         a) Transport Vans and Trucks (TRV)
         b) Transport (converted) Busses (TRB)
      5. Morgue (MRG) Body Transport
         a) Hearses (HRS)
         b) Trucks, vans, busses, other (OTV)
   C. Tertiary Medical Transportation (MT3). Those vehicles currently operating (and staffed) which are not in the public safety sector, nor designed for transporting the sick and/or injured, yet operate within the county.
      1. Taxi Cabs (TXIC)
         a) Company A (COMA)
         b) Company B (COMB)
         c) Company C (COMC)
         d) Company D (COMD)
         e) Company E (COME)
         f) Company F (COMF)
         g) Company G (COMG)
         h) Company H (COMH)
         i) Company I (COMI)
         j) Company J (COMJ)
         k) Company K (COMK)
         l) Company L (COML)
         m) Company M (COMM)
         n) Company N (COMN)
         o) Company O (COMO)
         p) Company P (COMP)
         q) Company Q (COMQ)
         r) Company R (COMR)
         s) Company S (COMS)
         t) Company T (COMT)
         u) Company U (COMU)
         v) Company V (COMV)
         w) Company W (COMW)
         x) Company X (COMX)
         y) Company Y (COMY)
         z) Company Z (COMZ)
      2. All Bus Lines (TRB). If converted list (CONVER)
         a) Private Bus Lines (PRBUS)
            (1) Company A (COMA)
            (2) Company B (COMB)
            (3) Company C (COMC)
            (4) Company D (COMD)
            (5) Company E (COME)
            (6) Company F (COMF)
            (7) Company G (COMG)
            (8) Company H (COMH)
            (9) Company I (COMI)
            (10) Company J (COMJ)
            (11) Company K (COMK)
            (12) Company L (COML)
            (13) Company M (COMM)
            (14) Company N (COMN)
            (15) Company O (COMO)
            (16) Company P (COMP)
            (17) Company Q (COMQ)
            (18) Company R (COMR)
            (19) Company S (COMS)
            (20) Company T (COMT)
            (21) Company U (COMU)
            (22) Company V (COMV)
            (23) Company W (COMW)
            (24) Company X (COMX)
            (25) Company Y (COMY)
            (26) Company Z (COMZ)
         b) Public Bus Lines (PUBUS)
            (1) Entity A (ENTA)
            (2) Entity B (ENTB)
            (3) Entity C (ENTC)
            (4) Entity D (ENTD)
            (5) Entity E (ENTE)
            (6) Entity F (ENTF)
            (7) Entity G (ENTG)
            (8) Entity H (ENTH)
            (9) Entity I (ENTI)
            (10) Entity J (ENTJ)
            (11) Entity K (ENTK)
            (12) Entity L (ENTL)
            (13) Entity M (ENTM)
            (14) Entity N (ENTN)
            (15) Entity O (ENTO)
            (16) Entity P (ENTP)
            (17) Entity Q (ENTQ)
            (18) Entity R (ENTR)
            (19) Entity S (ENTS)
            (20) Entity T (ENTT)
            (21) Entity U (ENTU)
            (22) Entity V (ENTV)
            (23) Entity W (ENTW)
            (24) Entity X (ENTX)
            (25) Entity Y (ENTY)
            (26) Entity Z (ENTZ)
         c) School Bus lines (SCBUS)
            (1) School A (SCHA)
            (2) School B (SCHB)
            (3) School C (SCHC)
            (4) School D (SCHD)
            (5) School E (SCHE)
            (6) School F (SCHF)
            (7) School G (SCHG)
            (8) School H (SCHH)
            (9) School I (SCHI)
            (10) School J (SCHJ)
            (11) School K (SCHK)
            (12) School L (SCHL)
            (13) School M (SCHM)
            (14) School N (SCHN)
            (15) School O (SCHO)
            (16) School P (SCHP)
            (17) School Q (SCHQ)
            (18) School R (SCHR)
            (19) School S (SCHS)
            (20) School T (SCHT)
            (21) School U (SCHU)
            (22) School V (SCHV)
            (23) School W (SCHW)
            (24) School X (SCHX)
            (25) School Y (SCHY)
            (26) School Z (SCHZ)
   D. Quaternary Medical Transportation (MT4). Those vehicles not currently operating (but functional) due solely to personnel shortage, which are not in the public safety sector, nor designed for transporting the sick and/or injured, yet operate within the county.
      1. Taxi Cabs (TXIC)
         a) Company A (COMA)
         b) Company B (COMB)
         c) Company C (COMC)
         d) Company D (COMD)
         e) Company E (COME)
         f) Company F (COMF)
         g) Company G (COMG)
         h) Company H (COMH)
         i) Company I (COMI)
         j) Company J (COMJ)
         k) Company K (COMK)
         l) Company L (COML)
         m) Company M (COMM)
         n) Company N (COMN)
         o) Company O (COMO)
         p) Company P (COMP)
         q) Company Q (COMQ)
         r) Company R (COMR)
         s) Company S (COMS)
         t) Company T (COMT)
         u) Company U (COMU)
         v) Company V (COMV)
         w) Company W (COMW)
         x) Company X (COMX)
         y) Company Y(COMY)
         z) Company Z (COMZ)
      2. All Bus Lines (TRB). If converted list (CONVER)
         a) Private Bus Lines (PRBUS)
            (1) Company A (COMA)
            (2) Company B (COMB)
            (3) Company C (COMC)
            (4) Company D (COMD)
            (5) Company E (COME)
            (6) Company F (COMF)
            (7) Company G (COMG)
            (8) Company H (COMH)
            (9) Company I (COMI)
            (10) Company J (COMJ)
            (11) Company K (COMK)
            (12) Company L (COML)
            (13) Company M (COMM)
            (14) Company N (COMN)
            (15) Company O (COMO)
            (16) Company P (COMP)
            (17) Company Q (COMQ)
            (18) Company R (COMR)
            (19) Company S (COMS)
            (20) Company T (COMT)
            (21) Company U (COMU)
            (22) Company V (COMV)
            (23) Company W (COMW)
            (24) Company X (COMX)
            (25) Company Y (COMY)
            (26) Company Z (COMZ)
         b) Public Bus Lines (PUBUS)
            (1) Entity A (ENTA)
            (2) Entity B (ENTB)
            (3) Entity C (ENTC)
            (4) Entity D (ENTD)
            (5) Entity E (ENTE)
            (6) Entity F (ENTF)
            (7) Entity G (ENTG)
            (8) Entity H (ENTH)
            (9) Entity I (ENTI)
            (10) Entity J (ENTJ)
            (11) Entity K (ENTK)
            (12) Entity L (ENTL)
            (13) Entity M (ENTM)
            (14) Entity N (ENTN)
            (15) Entity O (ENTO)
            (16) Entity P (ENTP)
            (17) Entity Q (ENTQ)
            (18) Entity R (ENTR)
            (19) Entity S (ENTS)
            (20) Entity T (ENTT)
            (21) Entity U (ENTU)
            (22) Entity V (ENTV)
            (23) Entity W (ENTW)
            (24) Entity X (ENTX)
            (25) Entity Y (ENTY)
            (26) Entity Z (ENTZ)
         c) School Bus lines (SCBUS)
            (1) School A (SCHA)
            (2) School B (SCHB)
            (3) School C (SCHC)
            (4) School D (SCHD)
            (5) School E (SCHE)
            (6) School F (SCHF)
            (7) School G (SCHG)
            (8) School H (SCHH)
            (9) School I (SCHI)
            (10) School J (SCHJ)
            (11) School K (SCHK)
            (12) School L (SCHL)
            (13) School M (SCHM)
            (14) School N (SCHN)
            (15) School O (SCHO)
            (16) School P (SCHP)
            (17) School Q (SCHQ)
            (18) School R (SCHR)
            (19) School S (SCHS)
            (20) School T (SCHT)
            (21) School U (SCHU)
            (22) School V (SCHV)
            (23) School W (SCHW)
            (24) School X (SCHX)
            (25) School Y (SCHY)
            (26) School Z (SCHZ)
   E. Fifth Level Medical Transportation (MT5). Those vehicles (and staff) provided by out of county mobile response entities (such as military agencies, federal agencies, international agencies, Red Cross, and others) for an in county medical response. These will be required to input capabilities (RDDWR³) or other FFDI¹ via FT² consistent with the various subcategories prior to response.
      1. Ambulances (AMB). Government or private
         a) Advanced Life Support (ALS)
         b) Basic Life Support (BLS)
         c) Wheelchair vans, cargo vans, busses, fire department vans and busses, other non ambulance vehicles (OTV)
      2. Police (POL)
         a) Squad Cars (SQC)
         b) Vans, busses, and other (OTV)
      3. Corrections (CORR)
         a) Transport Vans (TRV)
         b) Transport Busses (TRB)
      4. Animal Control (ANMCTR)
         a) Transport vans and trucks (TRV)
         b) Transport (converted) Busses (TRB)
      5. Morgue (MRG) Body Transport
         a) Hearses (HRS)
         b) Trucks, vans, busses, other (OTV)
IV. EVACUATION TRANSPORTATION (EVACT). Those vehicles, routes, maintenance, shelters, and established instruction protocols required for a mass exodus of all social structures of man and beast out of one or more counties, utilizing resources from within and without of the county.
   A. Foot Traffic (FOOTTR)
      1. Men, Women, and Children (MEN, WOM, CHI)
         a) Instructed to Take Shelter (ITTS)
            (1) Directed to Fall-out Shelter (DTFOS)
            (2) Directed to Nearest Basement (DTNB)
         b) Instructed to Walk to Specific Hub (ITWTSH) within the county, be it a medical facility (MF1 through MF6) or a back-up facility (FBU)
            (1) Immediately (IMMED)
            (2) At some future pre-determined time (PAUSE)
         c) Instructed to Walk Toward Out of County Hub (ITWTOOCH)
            (1) Immediately (IMMED)
            (2) At some future pre-determined time (PAUSE)
      2. Animal Control (ANMCTR). All animals.
         a) Instructed to Take Shelter (ITTS)
            (1) Stay Put (STAY)
            (2) Go Underground (GOUNDER)
         b) Instructed to Walk to Specific Hub (ITWTSH) within the county
            (1) Immediately (IMMED)
            (2) At some future pre-determined time (PAUSE)
         c) Instructed to Walk Toward Out of County Hub (ITWOOCH)
            (1) Immediately (IMMED)
            (2) At some future pre-determined time (PAUSE)
      3. Incarcerated Men and Women (INCMEN, INCWOM)
         a) Instructed to take shelter (ITTS)
            (1) Directed to Fall-out Shelter (DTFOS).
            (2) Directed to Nearest Basement (DTNB)
         b) Instructed to Walk to Specific Hub (ITWTSH) within the county, be it a medical facility (MF1 through MF6) or a back-up facility (FBU)
            (1) Immediately (IMMED)
            (2) At some future pre-determined time (PAUSE)
         c) Instructed to Walk Toward Out of County Hub (ITWTOOCH)
            (1) Immediately (IMMED)
            (2) At some future pre-determined time (PAUSE)
   B. Personal Vehicles (PERVEC). Car pool requirements.
      1. In County Vehicles to Out of County (ICVTOOC)
         a) Men, Women, Children (MEN, WOM, CHI)
            (1) Instructed to Park Vehicle and Walk to Nearest Hub (DTPVAWTNH) in county
            (a) Immediately (IMMED)
            (b) At some future pre-determined time (PAUSE)
            (2) Instructed to Drive Toward Out of County Hub (ITDTOOCH)
            (a) Immediately (IMMED)
            (b) At some future pre-determined time (PAUSE)
      2. Out of County Vehicle to In County Hub (OOCVTICH)
         a) Immediately (IMMED)
         b) At some future pre-determined time (PAUSE)
   C. Busses (PRBUS, PUBUS, SCBUS). To be further identified by capability to transport the sick and/or injured (MTEVAC), followed by amount.
      1. In County Vehicle to Out of County (ICVTOOC)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
      2. Out of County Vehicle to In County Hub (OOCVTICH)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
   D. Tractor Trailers (TRACTR). Each county will be required to maintain a pre-determined amount of semi tractor trailers stocked with provisions (fuel, food, water, heat, sanitation, first aid kits) consistent with the capacity for evacuation (MEN, WOM, CHI, ANIMAL, INCMEN, INCWOM).
      1. In County Vehicle to Out of County (ICVTOOC)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
      2. Out of County Vehicle to In County Hub (OOCVTICH)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
   E. Trains (TRAIN). Each county will be required to maintain a pre-determined amount of box cars and engines stocked with provisions (fuel, food, water, heat, sanitation, first aid kits) consistent with the capacity for evacuation (MEN, WOM, CHI, ANIM, INCMEN, INCWOM) as well as to identify a number of hubs for egress, considered back-up facilities (FBU).
      1. In County Vehicle to Out of County (ICVTOOC)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
      2. Out of County Vehicle to In County Hub (OOCVTICH)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
   F. Aircraft (AIRCRFT). Each county will be required to maintain (through agreements) a pre-determined amount of aircraft (of various classes), fully stocked for evacuation from within county and, in extremes, for out of county response. Also, a number of alternative runway options with their corresponding hubs to be identified.
      1. In County Vehicle to Out of County (ICVTOOC)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
      2. Out of County Vehicle to In County Hub (OOCVTICH)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
   G. Watercraft (WTRCRFT). Each county (where applicable) will be required to maintain (currently or readily) a pre-determined amount of watercraft, fully stocked (fuel, food, water, heat, sanitation, first aid kits), consistent with evacuation capacity (MEN, WOM, CHI, ANIMAL, INCMEN, INCWOM) as well as to identify a number of hubs for egress, considered back-up facilities (FBU).
      1. In County Vehicle to Out of County (ICVTOOC)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
      2. Out of County Vehicle to In County Hub (OOCVTICH)
         a) Men, Women, and Children (MEN, WOM, CHI)
            (1) Instructed to Rendezvous at In County Hub (ITRAICH)
            (a) Immediately (IMMED)
            (b) At some future pre-determined time (PAUSE)
         b) Animal Control (ANMCTR). All animals.
            (1) Instructed to Rendezvous at In County Hub (ITRAICH)
            (a) Immediately (IMMED)
            (b) At some future pre-determined time (PAUSE)
         c) Incarcerated Men and Women (INCMEN, INCWOM)
            (1) Instructed to Rendezvous at In County Hub (ITRAICH)
            (a) Immediately (IMMED)
            (b) At some future pre-determined time (PAUSE)
V. MEDICAL EQUIPMENT STATUS (MEQ). Medical Equipment refers to the various classes of high tech and low tech equipment (and their combinations), the corresponding supply inventory, manufacture and repair capabilities within (or to be brought in) the county boundaries.
   A. Primary Medical Equipment (MEQ1). To include inventories of all medical equipment currently in service at all primary, secondary, and seventh level (MF1, MF2, MF7) medical facilities within the county. To also identify back-up supply inventories, manufacture, and repair capabilities, with further suffix designations for that equipment which is mobile (MOBILE) and/or EMP Proof (EMPPRO)
      1. Radiologic Angiographs (RADANG). Further identified by specific organ system(s) vascular application.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      2. Positron Emission Tomography Scanners (PET)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      3. Magnetic Resonance Imaging Scanners (MRI)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      4. Computerized Axial Tomography Scanners (CAT)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      5. Electroencephalogram Scanners (EEG). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      6. Roentgenograms (XRAY). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      7. Cardiac Monitors (ECG). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      8. Anesthetic and Non Anesthetic Ventilators (ANESTVENT, VENT). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      9. Hyperbaric Chambers (HYPERBRCH). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      10. Burn Tubs (BUTUB). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      11. Laboratory Capable Equipment (LABRTYEQ). To include all forms (CBC, electrolytes, toxicology, type and cross, blood bank storage, centrifuge, incubators, microscopes, etc.) and to be so further identified as each following subcategory is so applied to each.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      12. Intravenous Pump Equipment (IVPUMP). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      13. Surgical Tools (SURGTOOL). To include all forms (as well as sterilization equipment) and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      14. Miscellaneous One (MISCONE). Syringes, needles, IV(peripheral and central), catheters, Foley catheters, suction, chest tubes, vacuum bottles, endotracheal tubes, nasogastric tubes, intravenous tubing, vials, ampoules.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      15. Miscellaneous Two (MISCTWO). Dressings and sutures of all kinds and to be so further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      16. Miscellaneous Three (MISCTHR). Linen, linen sterilization and body bags of all kinds, to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
   B. Secondary Medical Equipment (MEQ2). To include inventories of all medical equipment not currently in service (within the county), located at tertiary and quaternary medical facilities (MF3, MF4) and elsewhere. To also identify back-up supply inventories, manufacture and repair capabilities, with further suffix designations for equipment that is mobile (MOBILE) and/or EMP Proof (EMPPRO). Secondary Medical Equipment (MEQ2) provides the identical sixteen numbered subcategories for data input as under primary medical equipment (MEQ1).
      1. Radiologic Angiographs (RADANG). Further identified by specific organ system(s) vascular application.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      2. Positron Emission Tomography Scanners (PET)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      3. Magnetic Resonance Imaging Scanners (MRI)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      4. Computerized Axial Tomography Scanners (CAT)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      5. Electro Encephalogram Scanners (EEG). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      6. Roentgenograms (XRAY). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      7. Cardiac Monitors (ECG). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      8. Anesthetic and Non Anesthetic Ventilators (ANESTVENT, VENT). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      9. Hyperbaric Chambers (HYPERBRCH). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      10. Burn Tubs (BUTUB). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      11. Laboratory Capable Equipment (LABRTYEQ). To include all forms (CBC, electrolytes, toxicology, type and cross, blood bank storage, centrifuge, incubators, microscopes, etc.) and to be so further identified as each following subcategory is so applied to each.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      12. Intravenous Pump Equipment (IVPUMP). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      13. Surgical Tools (SURGTOOL). To include all forms (as well as sterilization equipment) and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      14. Miscellaneous One (MISCONE). Syringes, needles IV(peripheral and central), catheters, Foley catheters, suction, chest tubes, vacuum bottles, endotracheal tubes, nasogastric tubes, intravenous tubing, vials, ampules.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairnen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      15. Miscellaneous Two (MISCTWO). Dressings and sutures of all kinds and to be so further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      16. Miscellaneous Three (MISCTHR). Linen, linen sterilization and body bags of all kinds, to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
   C. Tertiary Medical Equipment (MEQ3). To include semi trailers with tractor available, within the county, prepared for rapid deployment, containing all the necessary medical equipment as listed on sixteen numbered subcategories under primary and secondary medical equipment (MEQ1, MEQ2) required to upgrade a secondary, tertiary, or quaternary medical facility (MF2, MF3, MF4) to a primary medical facility (MF1).
   D. Quaternary Medical Equipment (MEQ4). To include inventories of all medical equipment to be made available from outside the county by mobile response entities (military agencies, federal agencies, international agencies, Red Cross, and others), which will identify back-up supply inventories, manufacture and repair capabilities, with further suffix designations for that equipment which is mobile (MOBILE) and/or EMP Proof (EMPPRO). These relief agencies will be provided the identical sixteen numbered subcategories as under primary and secondary medical equipment (MP1, MP2) for input of data prior to response.
      1. Radiologic Angiographs (RADANG). Further identified by specific organ system(s) vascular application.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      2. Positron Emission Tomography Scanners (PET)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      3. Magnetic Resonance Imaging Scanners (MRI)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      4. Computerized Axial Tomography Scanners (CAT)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      5. Electroencephalogram Scanners (EEG). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      6. Roentgenograms (XRAY). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      7. Cardiac Monitors (ECG). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      8. Anesthetic and Non Anesthetic Ventilators (ANESTVENT, VENT). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      9. Hyperbaric Chamnbers (HYPERBRCH). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      10. Burn Tubs (BUTUB). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      11. Laboratory Capable Equipment (LABRTYEQ). To include all forms (CBC, electrolytes, toxicology, type and cross, blood bank storage, centrifuge, incubators, microscopes, etc.) and to be so further identified as each following subcategory is so applied to each.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      12. Intravenous Pump Equipment (IVPUMP). To include all forms and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      13. Surgical Tools (SURGTOOL). To include all forms (as well as sterilization equipment) and to so be further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      14. Miscellaneous One (MISCONE). Syringes, needles, IV(peripheral and central), catheters, Foley catheters, suction, chest tubes, vacuum bottles, endotracheal tubes, nasogastric tubes, intravenous tubing, vials, ampoules.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      15. Miscellaneous Two (MISCTWO). Dressings and sutures of all kinds and to be so further identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
      16. Miscellaneous Three (MISCTHR). Linen, linen sterilization and body bags of all kinds, to so be flurther identified.
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUNT)
         d) As is Capability (ASISCAP), necessary accessory surplus stock
            (1) Manufacture Capabilities (MANCAP)
            (a) Within Facility (INFAC)
            (b) Within County (INCOUN)
            (2) Amount on Hand (AMONHAN)
            (a) Within Facility (INFAC)
            (b) Within County (INCOUN)
   E. Fifth Level Medical Equipment (MEQ5). To include the entire contents, as required by law, of an advanced life support ambulance and to be located within the county at various pre-determined fifth level medical facilities (MF5). Back-up supply inventories, manufacture, repair, and EMP Proof (EMPPRO) to be noted. Quaternary medical equipment will also contain communications (CMEQBU) and be located at fifth level medical facilities (MF5) near identified back-up facility evaluation hubs (FBUEVACH)
   F. Sixth Level Medical Equipment (MEQ6). To include the entire contents, as required by law, of a basic life support ambulance and to be located within the county at all participating back-up facilities (FBU) and back-up facility evacuation hubs (FBUEVACH). To be provided or utilize back-up facility communications (CFBU) as well as identify and procure back-up supply inventories.
VI. PHARMACY FACILITY STATUS (PHARMF). Those structures, personnel, equipment, production, repair, and supplies available at a county level and provided to county facilities (MF1 through MF6, FBU, and FBUEVACH) of which will each be required to maintain a pre-determined emergency stock on hand.
   A. Primary Pharmacy Facility (PHARMF1). Those fixed structures within the county providing personnel, raw materials, equipment, and equipment repair for pharmaceutical production of county required stock items for man and beast.
      1. Gasses (GAS). Including oxygen, anesthetic gasses, and other medical gasses.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      2. Anesthetics, Paralytics, Narcotics, and Sedatives (APARNARSED). Those solutions, compounds, elixirs, etc. required for rapid sequence intubation, acute pain, and anxiety management to be available for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      3. Insulin and Oral Hypoglycemics (INSULIN). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      4. Cardiac Anti Dysrhythmics (CARANTDYSRYTH). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      5. Respiratory Agonists (RESPAG). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      6. Antibiotics, antiviral, antimyco, antifungal, and standard poison anecdotes (ANTIBIOT). To include the frequently utilized and effective varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      7. Sterile Electrolyte Solutions (STELSOL). Those common and frequently utilized solutions of all common varieties able to be synthetically or otherwise manufactured for all applicable parenteral and enteral routes as well as the corresponding storage containers. (Examples: IV solutions of normal saline and 1000 ml sterile container, 500 ml of sterile water for topical and sterile container, 50 ml of 50% dextrose and sterile glass syringe.)
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      8. Culture Media (CULTMEDIA). Those common and frequently utilized media for identifying bacteria, viruses, mycoplasms, and funguses from either parenteral or enteral sources. (Examples: aerobic and anaerobic blood media and sterile containers, Petri dishes and sterile swabs.)
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      9. Disposable Biomedical Supplies (DISPBIOMED). Those common, necessary and frequently utilized disposable items listed under primary medical equipment (MEQ1, Number 14) and able to be manufactured.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
   B. Secondary Pharmacy Facility (PHARMF2). Those mobile structures within the county providing personnel, raw materials, equipment and equipment repair for pharmaceutical production of county required stock items for man and beast.
      1. Gasses (GAS). Including oxygen, anesthetic gasses, and other medical gasses.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      2. Anesthetics, Paralytics, Narcotics, and Sedatives (APARNARSED). Those solutions, compounds, elixirs, etc. required for rapid sequence intubation, acute pain, and anxiety management to be available for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      3. Insuing and Oral Hypoglycemics (INSULIN). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      4. Cardiac Anti Dysrhythmics (CARANTDYSRYTH). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      5. Respiratory Agonists (RESPAG). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      6. Antibiotics, antiviral, antimyco, antifuingal, and standard poison anecdotes (ANTIBIOT). To include the frequently utilized and effective varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      7. Sterile Electrolyte Solutions (STELSOL). Those common and frequently utilized solutions of all common varieties able to be synthetically or otherwise manufactured for all applicable parenteral and enteral routes as well as the corresponding storage containers. (Examples: IV solutions of normal saline and 1000 ml sterile container, 500 ml of sterile water for topical and sterile container, 50 ml of 50% dextrose and sterile glass syringe.)
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      8. Culture Media (CULTMEDIA). Those common and frequently utilized media for identifying bacteria, viruses, mycoplasms, and funguses from either parenteral or enteral sources. (Examples: aerobic and anaerobic blood media and sterile containers, Petri dishes and sterile swabs.)
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      9. Disposable Biomedical Supplies (DISPBIOMED). Those common, necessary and frequently utilized disposable items listed under primary medical equipment (MEQ1, Number 14) and able to be manufactured.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
   C. Tertiary Pharmacy Facility (PHARMF3). Those structures and personnel able to provide stock inventory of the following nine listed subcategories for man and beast.
      1. Gasses (GAS). Including oxygen, anesthetic gasses, and other medical gasses.
      2. Anesthetics, Paralytics, Narcotics, and Sedatives (APARNARSED). Those solutions, compounds, elixirs, etc. required for rapid sequence intubation, acute pain, and anxiety management to be available for all applicable parenteral and enteral routes.
      3. Insuing and Oral Hypoglycemics (INSULIN). To include all standard varieties able to be synthetically or otherwise manufactured for all applicable parenteral and enteral routes.
      4. Cardiac Anti Dysrhythmics (CARANTDYSRYTH). To include all standard varieties able to be synthetically or otherwise manufactured for all applicable parenteral and enteral routes.
      5. Respiratory Agonists (RESPAG). To include all standard varieties able to be synthetically or otherwise manufactured for all applicable parenteral and enteral routes.
      6. Antibiotics, antiviral, antimyco, antifungal, and standard poison anecdotes (ANTIBIOT). To include the frequently utilized and effective varieties able to be synthetically or otherwise manufactured for all applicable parenteral and enteral routes.
      7. Sterile Electrolyte Solutions (STELSOL). Those common and frequently utilized solutions of all common varieties able to be synthetically or otherwise manufactured for all applicable parenteral and enteral routes as well as the corresponding storage containers. (Examples: IV solutions of normal saline and 1000 ml sterile container, 500 ml of sterile water for topical and sterile container, 50 ml of 50% dextrose and sterile glass syringe.)
      8. Culture Media (CULTMEDIA). Those common and frequently utilized media for identifying bacteria, viruses, mycoplasms, and funguses from either parenteral or enteral sources. (Examples: aerobic and anaerobic blood media and sterile containers, Petri dishes and sterile swabs.)
      9. Disposable Biomedical Supplies (DISPBIOMED). Those common, necessary and frequently utilized disposable items listed under primary medical equipment (MEQ1, Number 14) and able to be manufactured.
   D. Quaternary Pharmacy Facility (PHARMF4). Those mobile structures brought into the county from mobile response entities (military agencies, federal agencies, international agencies, Red Cross and others) able to provide personnel, raw materials, equipment and equipment repair for pharmaceutical production of county required stock items for man and beast.
      1. Gasses (GAS). Including oxygen, anesthetic gasses, and other medical gasses.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      2. Anesthetics, Paralytics, Narcotics, and Sedatives (APARNARSED). Those solutions, compounds, elixirs, etc. required for rapid sequence intubation, acute pain, and anxiety management to be available for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      3. Insuing and Oral Hypoglycemics (INSULIN). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      4. Cardiac Anti Dysrhythmics (CARANTDYSRYTH). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      5. Respiratory Agonists (RESPAG). To include all standard varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      6. Antibiotics, antiviral, antimyco, antifungal, and standard poison anecdotes (ANTIBIOT). To include the frequently utilized and effective varieties able to be synthetically or otherwise manufactured for all applicable parenteral and enteral routes.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      7. Sterile Electrolyte Solutions (STELSOL). Those common and frequently utilized solutions of all common varieties able to be synthetically or otherwise manufactured for all applicable parenteral and enteral routes as well as the corresponding storage containers. (Examples: IV solutions of normal saline and 1000 ml sterile container, 500 ml of sterile water for topical and sterile container, 50 ml of 50% dextrose and sterile glass syringe.)
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      8. Culture Media (CULTMEDIA). Those common and frequently utilized media for identifying bacteria, viruses, mycoplasms, and funguses from either parenteral or enteral sources. (Examples: aerobic and anaerobic blood media and sterile containers, Petri dishes and sterile swabs.)
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
      9. Disposable Biomedical Supplies (DISPBIOMED). Those common, necessary and frequently utilized disposable items listed under primary medical equipment (MEQ1, Number 14) and able to be manufactured.
         a) Raw Materials (RAWMAT)
         b) Production Equipment (PRODEQ)
            (1) Production Equipment Production Capabilities (PEPC)
            (2) Production Equipment Spare Parts Capabilities (PESPC)
            (3) Production Equipment Repairmen (PEREP)
         c) Production Personnel (PRODPER)
         d) Production Capacity (PRODCAP)
         e) Product Storage Capacity (PRODSTORCAP)
            (1) Product Storage Container Manufacture Capabilities (PRODSTORMFGCAP)
   E. Fifth Level Pharmacy Facility (PHARMF5). Those structures, whether fixed or mobile, production or stock that exist outside the county able to provide stock pharmaceuticals to within the county for man and beast.
      1. Gasses (GAS). Including oxygen, anesthetic gasses, and other medical gasses.
      2. Anesthetics, Paralytics, Narcotics, and Sedatives (APARNARSED). Those solutions, compounds, elixirs, etc. required for rapid sequence intubation, acute pain, and anxiety management to be available for all applicable parenteral and enteral routes.
      3. Insuing and Oral Hypoglycemics (INSULIN). To include all standard varieties able to be synthetically or otherwise manufactured for all applicable parenteral and enteral routes.
      4. Cardiac Anti Dysrhythmics (CARANTDYSRYTH). To include all standard varieties able to be synthetically or otherwise manufactured for all applicable parenteral and enteral routes.
      5. Respiratory Agonists (RESPAG). To include all standard varieties able to be synthetically or otherwise manufactured for all applicable parenteral and enteral routes.
      6. Antibiotics, antiviral, antimyco, antifungal, and standard poison anecdotes (ANTIBIOT). To include the frequently utilized and effective varieties able to be synthetically or otherwise manufactured for all applicable parenteral and enteral routes.
      7. Sterile Electrolyte Solutions (STELSOL). Those common and frequently utilized solutions of all common varieties able to be synthetically or otherwise manufactured for all applicable parenteral and enteral routes as well as the corresponding storage containers. (Examples: IV solutions of normal saline and 1000 ml sterile container, 500 ml of sterile water for topical and sterile container, 50 ml of 50% dextrose and sterile glass syringe.)
      8. Culture Media (CULTMEDIA). Those common and frequently utilized media for identifying bacteria, viruses, mycoplasms, and funguses from either parenteral or enteral sources. (Examples: aerobic and anaerobic blood media and sterile containers, Petri dishes and sterile swabs.)
      9. Disposable Biomedical Supplies (DISPBIOMED). Those common, necessary and frequently utilized disposable items listed under primary medical equipment (MEQ1, Number 14) and able to be manufactured.
VII. COMMUNICATIONS (C). To include the numerous format forms for data entry and data reception (FFDI and FFDR respectively) occurring via the various forms of transmission FT.
   A. Primary Communication Status (C1). Primary communication for 1234ABCDCOUNTYSTATUS will be via secure internet connections (closed, wireless, ad hoc, satellite) utilizing firewall/router to access 1234ABCDCOUNTYSTATUS ZONE via IFSLGOVWATCH Network.
      1. Within County to Within County Communication (INCOTOINCO).
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         2. Within County to Without County Communication (INCOTOOUTCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO) c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
      3. Without County to Within County Communication (OUTCOTOINCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
   B. Secondary Communication Status (C2). Secondary communication for 1234ABCDCOUNTYSTATUS will be via secure telephone connections, whether land line, wireless or satellite.
      1. Within County to Within County Communication (INCOTOINCO).
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
      2. Within County to Without County Communication (INCOTOOUTCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
      3. Without County to Within County Communication (OUTCOTOINCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
   C. Tertiary Communications (C3). Tertiary communications for 1234ABCDCOUNTYSTATUS will be via pre-existing radio networks (FM, VHF, UHF, microwave and satellite, base, mobile, portable, repeater dependent or ad hoc).
      1. Within County to Within County Communication (INCOTOINCO).
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
      2. Within County to Without County Communication (INCOTOOUTCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
      3. Without County to Within County Communication (OUTCOTOINCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
   D. Quaternary Communications (C4). Quaternary communications for 1234ABCDCOUNTYSTATUS will be via existing short wave and citizen band networks (base, mobile, portable, repeater dependent or ad hoc).
      1. Within County to Within County Communication (INCOTOINCO).
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
      2. Within County to Without County Communication (INCOTOOUTCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
      3. Without County to Within County Communication (OUTCOTOINCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
   E. Fifth Level Communications (C5). Fifth level communications for 1234ABCDCOUNTYSTATUS will be via pigeons with USB chips (and other FFDI/FFDS/FFDR) as well as other pre modern communication methods.
      1. Within County to Within County Communication (INCOTOINCO).
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
      2. Within County to Without County Communication (INCOTOOUTCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
      3. Without County to Within County Communication (OUTCOTOINCO)
         a) Subcategory to Subcategory (SUBTOSUB).
            (1) Data Entry (DATENT) RDDWR
            (2) Data Access (DATACC) DDWDR and FILETRANSFER
            (3) Data Storage (DATSTO)
         b) Subcategory to Main Category (SUBTOCAT)
            (1) Data Entry (DATENT) RDDWR
            (2) Data Access (DATACC) DDWDR and FILETRANSFER
            (3) Data Storage (DATSTO)
         c) Subcategory to Main (SUBTOMAIN)
            (1) Data Entry (DATENT) RDDWR
            (2) Data Access (DATACC) DDWDR and FILETRANSFER
            (3) Data Storage (DATSTO)
         d) Main Category to Subcategory (CATTOSUB)
            (1) Data Entry (DATENT) RDDWR
            (2) Data Access (DATACC) DDWDR and FILETRANSFER
            (3) Data Storage (DATSTO)
         e) Main Category to Main Category (CATTOCAT)
            (1) Data Entry (DATENT) RDDWR
            (2) Data Access (DATACC) DDWDR and FILETRANSFER
            (3) Data Storage (DATSTO)
         f) Main Category to Main (CATTOMAIN)
            (1) Data Entry (DATENT) RDDWR
            (2) Data Access (DATACC) DDWDR and FILETRANSFER
            (3) Data Storage (DATSTO)
         g) Main to Subcategory (MAINTOSUB)
            (1) Data Entry (DATENT) RDDWR
            (2) Data Access (DATACC) DDWDR and FILETRANSFER
            (3) Data Storage (DATSTO)
         h) Main to Main Category (MAINTOCAT)
            (1) Data Entry (DATENT) RDDWR
            (2) Data Access (DATACC) DDWDR and FILETRANSFER
            (3) Data Storage (DATSTO)
         i) Main to Main (MAINTOMAIN)
            (1) Data Entry (DATENT) RDDWR
            (2) Data Access (DATACC) DDWDR and FILETRANSFER
            (3) Data Storage (DATSTO)
   F. Sixth Level Communications (C6). Sixth level communications for 1234ABCDCOUNTYSTATUS will be via existing public broadcasting networks (TV—Cable, VHF, UHF and Radio—FM, AM) emergency broadcasting and/or emergency alert networks to provide evacuation instructions (EVACT) at a broadcast only level following authorization for broadcast (AUTHFOBRO) from sheriff.
   G. Seventh Level Communications (C7). Seventh level communications for 1234ABCDCOUNTYSTATUS will be via megaphones and existing public address systems (fixed and mobile) providing evacuation instructions (EVACT) at a broadcast only level following authorization for broadcast (AUTHFOBRO) from sheriff.
VIII. COUNTY WATER (CWATER). The water within a county, its purification, transport, storage and subsequent repair capabilities.
   A. Primary County Water Status (CWATER1). Primary county water status would be that city, township or village with the largest production/demand within the county.
      1. Sources (SOURCE)
         a) In City (INCITY)
            (1) Aquifer (AQUIF)
            (2) Lakes, Rivers (LAKRIV)
            (3) Rainwater Collection (RAINCOL)
         b) Out of City (OUTCITY)
            (1) Aquifer (AQUIF)
            (2) Lakes, Rivers (LAKRIV)
            (3) Rainwater Collection (RAINCOL)
      2. Purification Facilities (PURFAC)
         a) In City Fixed (INCITYFX)
         b) In City Mobile (INCITYMOB)
            (1) Independently Operating Large Capacity Units (IOLCU)
            (2) Distributed Electrical and Manual Residential Water Filter PUMPS (DEAMRWFP)
         c) Out of City Fixed (OUTCITYFX)
         d) Out of City Mobile (OUTCITYMOB)
            (1) Independently Operating Large Capacity Units (IOLCU)
            (2) Distributed Electrical and Manual Residential Water Filter Pumps (DEAMRWFP)
      3. Transport Capabilities (WATERTRANS)
         a) City Water Mains (CITYWTRMAIN)
         b) In City Mobile Water Tankers (INCITYMOBWATTNK)
         c) In City Residential Water Tanks (INCITYRESWATTNK)
         d) Out of City Mobile Water Tankers (OUTCITYMOBWATTNK)
         e) Out of City Residential Water Tanks (OUTCITYRESWATTNK)
      4. Storage Capabilities (WATERSTOR)
         a) In City Fixed Underground Pure Water Storage (INCITYFXUPWS)
         b) In City Fixed Above Ground Pure Water Storage (INCITYFXAPWS)
         c) In City Mobile Water Tankers (INCITYMOBWATTNK)
         d) In City Residential Water Tanks (INCITYRESWATTNK)
         e) In City Facility Water Tanks (INCITYFWATTNK) to include medical facilities, back-up facilities, and evacuation hubs
         f) Out of City Fixed Pure Water Storage (OUTCITYFXPWS)
         g) Out of City Mobile Water Tankers (OUTCITYMOBWATTNK)
IX. COUNTY FOOD (CFOOD). That food within a county, its production, transport, storage and subsequent repair capabilities.
   A. Primary County Food Status (CFOOD1). Those fixed structures within the county which are self supporting food production facilities.
      1. Protein (PROTEIN)
         a) Fresh (FRESH)
         b) Frozen (FROZEN)
         c) Non Perishable (NONPERISH)
            (1) Dry (DRY)
            (2) Canned (CANNED)
      2. Carbohydrates (CARBS)
         a) Fresh (FRESH)
         b) Frozen (FROZEN)
         c) Non Perishable (NONPERISH)
            (1) Dry (DRY)
            (2) Canned (CANNED)
      3. Fats (FATS)
         a) Fresh (FRESH)
         b) Frozen (FROZEN)
         c) Non Perishable (NONPERISH)
            (1) Dry (DRY)
            (2) Canned (CANNED)
      4. Micro Nutrients (MICRONUT), vitamins and minerals
         a) Fresh (FRESH)
         b) Frozen (FROZEN)
         c) Non Perishable (NONPERISH)
            (1) Dry (DRY)
            (2) Canned (CANNED)
   B. Secondary County Food Status (CFOOD2). Those mobile and/or nomadic entities within the county which are self supporting and self contained food production facilities.
      1. Protein (PROTEIN)
         a) Fresh (FRESH)
         b) Frozen (FROZEN)
         c) Non Perishable (NONPERISH)
            (1) Dry (DRY)
            (2) Canned (CANNED)
      2. Carbohydrates (CARBS)
         a) Fresh (FRESH)
         b) Frozen (FROZEN)
         c) Non Perishable (NONPERISH)
            (1) Dry (DRY)
            (2) Canned (CANNED)
      3. Fats (FATS)
         a) Fresh (FRESH)
         b) Frozen (FROZEN)
         c) Non Perishable (NONPERISH)
            (1) Dry (DRY)
            (2) Canned (CANNED)
      4. Micro Nutrients (MICRONUT), vitamins and minerals
         a) Fresh (FRESH)
         b) Frozen (FROZEN)
         c) Non Perishable (NONPERISH)
            (1) Dry (DRY)
            (2) Canned (CANNED)
   C. Tertiary County Food Status (CFOOD3). Those structures and personnel within the county able to provide stock inventory of the below listed four subcategories. (ex. grocery stores)
      1. Protein (PROTEIN)
         a) Fresh (FRESH)
         b) Frozen (FROZEN)
         c) Non Perishable (NONPERISH)
            (1) Dry (DRY)
            (2) Canned (CANNED)
      2. Carbohydrates (CARBS)
         a) Fresh (FRESH)
         b) Frozen (FROZEN)
         c) Non Perishable (NONPERISH)
            (1) Dry (DRY)
            (2) Canned (CANNED)
      3. Fats (FATS)
         a) Fresh (FRESH)
         b) Frozen (FROZEN)
         c) Non Perishable (NONPERISH)
            (1) Dry (DRY)
            (2) Canned (CANNED)
      4. Micro Nutrients (MICRONUT), vitamins and minerals
         a) Fresh (FRESH)
         b) Frozen (FROZEN)
         c) Non Perishable (NONPERISH)
            (1) Dry (DRY)
            (2) Canned (CANNED)
   D. Quaternary County Food Status (CFOOD4). Those mobile and/or nomadic entities brought into the county by the various forms of transportation which are self supporting and self contained food production facilities.
      1. Protein (PROTEIN)
         a) Fresh (FRESH)
         b) Frozen (FROZEN)
         c) Non Perishable (NONPERISH)
            (1) Dry (DRY)
            (2) Canned (CANNED)
      2. Carbohydrates (CARBS)
         a) Fresh (FRESH)
         b) Frozen (FROZEN)
         c) Non Perishable (NONPERISH)
            (1) Dry (DRY)
            (2) Canned (CANNED)
      3. Fats (FATS)
         a) Fresh (FRESH)
         b) Frozen (FROZEN)
         c) Non Perishable (NONPERISH)
            (1) Dry (DRY)
            (2) Canned (CANNED)
      4. Micro Nutrients (MICRONUT), vitamins and minerals
         a) Fresh (FRESH)
         b) Frozen (FROZEN)
         c) Non Perishable (NONPERISH)
            (1) Dry (DRY)
            (2) Canned (CANNED)
   E. Fifth Level County Food Status (CFOOD5). Those mobile or fixed structures which are brought into the county and able to provide stock inventory of the below listed four subcategories. (ex. grocery store suppliers, mobile food banks, mobile response entities)
      1. Protein (PROTEIN)
         a) Fresh (FRESH)
         b) Frozen (FROZEN)
         c) Non Perishable (NONPERISH)
            (1) Dry (DRY)
            (2) Canned (CANNED)
      2. Carbohydrates (CARBS)
         a) Fresh (FRESH)
         b) Frozen (FROZEN)
         c) Non Perishable (NONPERISH)
            (1) Dry (DRY)
            (2) Canned (CANNED)
      3. Fats (FATS)
         a) Fresh (FRESH)
         b) Frozen (FROZEN)
         c) Non Perishable (NONPERISH)
            (1) Dry (DRY)
            (2) Canned (CANNED)
      4. Micro Nutrients (MICRONUT), vitamins and minerals
         a) Fresh (FRESH)
         b) Frozen (FROZEN)
         c) Non Perishable (NONPERISH)
            (1) Dry (DRY)
            (2) Canned (CANNED)
X. COUNTY ANIMAL STATUS (CANIMAL). Those non-humanoid creatures residing within the county providing food, clothing, and enjoyment which also require food, water, and shelter.
   A. Livestock (LIVESTOCK). To include bovine, swine, sheep, goats, and mules.
      1. County Feed Demand (CFEEDDEM)
      2. County Feed Supply (CFEEDSUP)
         a) Manufacture Capabilities (MFGCAPB)
         b) Stock Inventory (STOCKINVEN)
      3. County Water Demand (CWATDEM)
      4. County Water Supply (CWATSUP)
      5. County Shelter Capabilities (CSHELTCAPB)
         a) Fixed (FIXED)
         b) Mobile/Portable (MOB/PORT)
      6. County Animal Medical Facilities (VETCIN)
         a) Veterinarians (VET)
         b) Veterinarian Techs (VETTECH)
         c) Pharmaceuticals (PHARM)
            (1) Production Capability (PRODCAP)
            (2) Stock Inventory Capacity (STOINCAP)
      7. Evacuation Plans (EVACPL)
         a) Foot (FOOTTR)
         b) Road (PERVEC, BUS, TRACTR)
         c) Rail (TRAIN)
         d) Air (AIRCRFT)
         e) Water (WTRCRFT)
   B. Poultry (POULTRY). To include chickens, turkeys, ducks and geese.
      1. County Feed Demand (CFEEDDEM)
      2. County Feed Supply (CFEEDSUP)
         a) Manufacture Capabilities (MFGCAPB)
         b) Stock Inventory (STOCKINVEN)
      3. County Water Demand (CWATDEM)
      4. County Water Supply (CWATSUP)
      5. County Shelter Capabilities (CSHELTCAPB)
         a) Fixed (FIXED)
         b) Mobile/Portable (MOB/PORT)
      6. County Animal Medical Facilities (VETCIN)
         a) Veterinarians (VET)
         b) Veterinarian Techs (VETTECH)
         c) Pharmaceuticals (PHARM)
            (1) Production Capability (PRODCAP)
            (2) Stock Inventory Capacity (STOINCAP)
      7. Evacuation Plans (EVACPL)
         a) Foot (FOOTTR)
         b) Road (PERVEC, BUS, TRACTR)
         c) Rail (TRAIN)
         d) Air (AIRCRFT)
         e) Water (WTRCRFT)
   C. Fish (FISH). To include county fish farms.
      1. County Feed Demand (CFEEDDEM)
      2. County Feed Supply (CFEEDSUP)
         a) Manufacture Capabilities (MFGCAPB)
         b) Stock Inventory (STOCKINVEN)
      3. County Water Demand (CWATDEM)
      4. County Water Supply (CWATSUP)
      5. County Shelter Capabilities (CSHELTCAPB)
         a) Fixed (FIXED)
         b) Mobile/Portable (MOB/PORT)
      6. County Animal Medical Facilities (VETCIN)
         a) Veterinarians (VET)
         b) Veterinarian Techs (VETTECH)
         c) Pharmaceuticals (PHARM)
            (1) Production Capability (PRODCAP)
            (2) Stock Inventory Capacity (STOINCAP)
      7. Evacuation Plans (EVACPL)
         a) Foot (FOOTTR)
         b) Road (PERVEC, BUS, TRACTR)
         c) Rail (TRAIN)
         d) Air (AIRCRFT)
         e) Water (WTRCRFT)
   D. Domestic (DOMESTIC). To include horses, dogs, cats, and rabbits.
      1. County Feed Demand (CFEEDDEM)
      2. County Feed Supply (CFEEDSUP)
         a) Manufacture Capabilities (MFGCAPB)
         b) Stock Inventory (STOCKINVEN)
      3. County Water Demand (CWATDEM)
      4. County Water Supply (CWATSUP)
      5. County Shelter Capabilities (CSHELTCAPB)
         a) Fixed (FIXED)
         b) Mobile/Portable (MOB/PORT)
      6. County Animal Medical Facilities (VETCIN)
         a) Veterinarians (VET)
         b) Veterinarian Techs (VETTECH)
         c) Pharmaceuticals (PHARM)
            (1) Production Capability (PRODCAP)
            (2) Stock Inventory Capacity (STOINCAP)
      7. Evacuation Plans (EVACPL)
         a) Foot (FOOTTR)
         b) Road (PERVEC, BUS, TRACTR)
         c) Rail (TRAIN)
         d) Air (AIRCRFT)
         e) Water (WTRCRFT)
   E. Zoological Gardens (ZOO). Those exotic species often far removed from their natural element.
      1. County Feed Demand (CFEEDDEM)
      2. County Feed Supply (CFEEDSUP)
         a) Manufacture Capabilities (MFGCAPB)
         b) Stock Inventory (STOCKINVEN)
      3. County Water Demand (CWATDEM)
      4. County Water Supply (CWATSUP)
      5. County Shelter Capabilities (CSHELTCAPB)
         a) Fixed (FIXED)
         b) Mobile/Portable (MOB/PORT)
      6. County Animal Medical Facilities (VETCIN)
         a) Veterinarians (VET)
         b) Veterinarian Techs (VETTECH)
         c) Pharmaceuticals (PHARM)
            (1) Production Capability (PRODCAP)
            (2) Stock Inventory Capacity (STOINCAP)
      7. Evacuation Plans (EVACPL)
         a) Foot (FOOTTR)
         b) Road (PERVEC, BUS, TRACTR)
         c) Rail (TRAIN)
         d) Air (AIRCRFT)
         e) Water (WTRCRFT)
   F. Wild (WILD). Those animals which exist in the wild as their natural element and available for food, clothing, and evacuation.
XI. CRIMINAL JUSTICE (CRMJUS). Those fixed or mobile incarceration facilities within the county which provide shelter, food, water, heat, sanitation, and medical care to long term or short term inmates.
   A. Primary Criminal Justice Status (CRMJUS1). To include those fixed and mobile incarceration facilities (occupied or unoccupied) within the county, regardless of jurisdiction.
      1. Military Prisons (MILPRIS)
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
         g) County Food Supply (CFOODSUP)
         h) Secured Shelter and Perimeter (SECSHAPER)
            (1) Fixed (FIXED)
            (2) Mobile/Portable (MOB/PORT)
         i) Heating Capabilities (HEATCAPB)
         j) Sanitation Capabilities (SANCAPB)
      2. Federal Prisons (FEDPRIS).
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
      3. State Prisons (STAPRIS).
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
      4. County Jails (COUNJAL)
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
      5. City Jails (CITYJAL)
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
   B. Secondary Criminal Justice Status (CRMJUS2). Secondary criminal justice status to include those mobile detachments within the county able to be deployed and provide temporary (90 days) incarceration in its entirety at any location.
      1. Seventh Level Medical Facilities (MF7)
         a) Medical Personnel (MP)
         b) Medical Equipment (MEQ)
         c) Pharmacy (PHARM)
      2. Evacuation Plans (EVACPL)
         a) Foot (FOOTTR)
         b) Road (PERVEC, BUS, TRACTR)
         c) Rail (TRAIN)
         d) Air (AIRCRFT)
         e) Water (WTRCRFT)
      3. Communications (C)
         a) Back-up Communications (CBU)
            (1) Communication Failure Frequency Algorithms (COMMFAILFQALG)
            (2) Communication Failure Algorithms (COMMFAILALG)
      4. County Water Demand (CWATDEM)
      5. County Water Supply (CWATSUP)
      6. County Food Demand (CFOODDEM)
      7. County Food Supply (CFOODSUP)
      8. Secured Shelter and Perimeter (SECSHAPER)
         a) Fixed (FIXED)
         b) Mobile/Portable (MOB/PORT)
      9. Heating Capabilities (HEATCAPB)
      10. Sanitation Capabilities (SANCAPB)
   C. Tertiary Criminal Justice Status (CRMJUS3). Tertiary criminal justice status to include those out of county mobile response entities (military agencies, federal agencies, international agencies, Red Cross, and others) able to provide fixed and/or mobile incarceration facilities inside the county with capabilities for any or all of the nine listed subcategories.
      1. Military Prisons (MILPRIS)
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
         g) County Food Supply (CFOODSUP)
         h) Secured Shelter and Perimeter (SECSHAPER)
            (1) Fixed (FIXED)
            (2) Mobile/Portable (MOB/PORT)
         i) Heating Capabilities (HEATCAPB)
         j) Sanitation Capabilities (SANCAPB)
      2. Federal Prisons (FEDPRIS).
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
      3. State Prisons (STAPRIS).
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
      4. County Jails (COUNJAL)
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
      5. City Jails (CITYJAL)
         a) Seventh Level Medical Facilities (MF7)
            (1) Medical Personnel (MP)
            (2) Medical Equipment (MEQ)
            (3) Pharmacy (PHARM)
         b) Evacuation Plans (EVACPL)
            (1) Foot (FOOTTR)
            (2) Road (PERVEC, BUS, TRACTR)
            (3) Rail (TRAIN)
            (4) Air (AIRCRFT)
            (5) Water (WTRCRFT)
         c) Communications (C)
            (1) Back-up Communications (CBU)
            (a) Communication Failure Frequency Algorithms (COMMFAILFQALG)
            (b) Communication Failure Algorithms (COMMFAILALG)
         d) County Water Demand (CWATDEM)
         e) County Water Supply (CWATSUP)
         f) County Food Demand (CFOODDEM)
   D. Quaternary Criminal Justice Status (CRMJUS4). Quaternary criminal justice status to include updates regarding capacity and capabilities of surrounding counties.
XII. PUBLIC SAFETY (PUBLSAFT). Those judicial agencies, law enforcement agencies (military, federal, state, county, city, and private), fire service agencies (public and private), and emergency medical services (public and private) operating within the county (on-duty and off) able to handle low to moderate level number 1 county incidents.
   A. Primary Public Safety Status (PUBLSAFTl). To include those on-duty personnel and equipment able to be re-deployed within the county and further identified by hazard duty availability.
      1. Judicial Agencies (JUDGE). To include those fixed or mobile structures and personnel able to render and record numerous and rapid judgments from traditional and non-traditional locations for large scale public safety incidents.
         a) Military (MILTRY)
         b) Federal (FED)
         c) State (STATE)
         d) County (COUNTY)
         e) City (CITY)
      2. Law Enforcement Agencies (LAWENF). To include those agency personnel trained and equipped to function in the capacity of law enforcement within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
      3. Fire Service Agencies (FIREDEP). To include those agency personnel trained and equipped to function in the capacity of fire suppression within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
      4. Emergency Medical Service Agencies (EMSDEP). To include those personnel (public and private) trained and equipped to function in the capacity of emergency medical services within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
   B. Secondary Public Safety Status (PUBLSAFT2). To include those off-duty personnel and/or functional idle equipment able to be deployed or re-deployed within the county and further identified by hazard duty availability.
      1. Judicial Agencies (JUDGE). To include those fixed or mobile structures and personnel able to render and record numerous and rapid judgments from traditional and non-traditional locations for large scale public safety incidents.
         a) Military (MILTRY)
         b) Federal (FED)
         c) State (STATE)
         d) County (COUNTY)
         e) City (CITY)
      2. Law Enforcement Agencies (LAWENF). To include those agency personnel trained and equipped to function in the capacity of law enforcement within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
      3. Fire Service Agencies (FIREDEP). To include those agency personnel trained and equipped to function in the capacity of fire suppression within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
      4. Emergency Medical Service Agencies (EMSDEP). To include those personnel (public and private) trained and equipped to function in the capacity of emergency medical services within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
   C. Tertiary Public Safety Status (PUBLSAFT3). To include those personnel (on-duty or off) and equipment within the public safety sector existing outside of the county and available for deployment within the county.
      1. Judicial Agencies (JUDGE). To include those fixed or mobile structures and personnel able to render and record numerous and rapid judgments from traditional and non-traditional locations for large scale public safety incidents.
         a) Military (MILTRY)
         b) Federal (FED)
         c) State (STATE)
         d) County (COUNTY)
         e) City (CITY)
      2. Law Enforcement Agencies (LAWENF). To include those agency personnel trained and equipped to function in the capacity of law enforcement within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
      3. Fire Service Agencies (FIREDEP). To include those agency personnel trained and equipped to function in the capacity of fire suppression within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
      4. Emergency Medical Service Agencies (EMSDEP). To include those personnel (public and private) trained and equipped to function in the capacity of emergency medical services within the county.
         a) Military (MILTRY)
         b) Federal (FED)
         c) State (STATE)
         d) County (COUNTY)
         e) City (CITY)
         f) Private (PRIVT)
         g) Back-up Facilities (FBU)
XIII. ELECTRICITY (ELECTRIC). To include that alternating and direct current produced, supplied and utilized within the county, as well as the necessary facilities, equipment, and personnel to produce same.
   A. Primary Electrical Facilities (ELECTRICFAC1). Those fixed facilities, personnel, equipment, networks, and easements existing within the county which constitute that referred to as the electrical grid.
      1. Personnel (P)
         a) Logistical (LOGIST)
         b) Engineers (ENGINR)
         c) Field (FIELD)
      2. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
      3. Communication (C)
         a) Back-up Communication (CBU)
      4. Fuel Type (FUELTYP). Atomic, fossil (coal, wood, petroleum), hydro, wind, solar, static.
         a) In County Production Capability (INCOPROCAP)
         b) In County Reserves (INCORESV)
         c) In County Demand (INCODEM)
      5. Storage (STORE)
      6. Back-up Facilities (FBU)
   B. Secondary Electrical Facilities (ELECTRICFAC2). Those fixed generators, personnel and equipment able to produce back-up electricity for a specific (non-electric) facility and/or transmit to other facilities.
      1. Personnel (P)
      2. Equipment (EQ)
         a) Spare Parts Capabilities (SPPARCAP)
         b) Repairmen Capabilities (RPMENCAP)
      3. Fuel Type (FUELTY)
         a) Reserves
      4. Storage (STORE)
   C. Tertiary Electrical Facilities (ELECTRICFAC3). Those mobile generators, personnel, and equipment within the county able to produce and provide electricity to sectors of the grid within the county.
      1. Personnel (P)
         a) Logistical (LOGIST)
         b) Engineers (ENGINR)
         c) Field (FIELD)
      2. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
      3. Communication (C)
         a) Back-up Communication (CBU)
      4. Fuel Type (FULTYP). Atomic, fossil (coal, wood, petroleum), hydro, wind, solar, static.
         a) In County Production Capability (INCOPROCAP)
         b) In County Reserves (INCORESV)
         c) In County Demand (INCODEM)
      5. Storage (STORE)
         a) In County Production Capability (INCOPROCAP)
         b) In County Reserves (INCORESV)
         c) In County Demand (INCODEM)
   D. Quaternary Electrical Facilities (ELECTRICFAC4). Those personal and residential electricity generators (of all types) and storage within the county able to provide off grid and small sector grid electricity.
      1. Estimates
      2. Fuel Reserve Estimates
   E. Fifth Level Electrical Facilities (ELECTRICFAC5). Those mobile generators, personnel, and equipment existing outside of the county able to produce and provide electricity to sectors of the grid within the county.
      1. Personnel (P)
         a) Logistical (LOGIST)
         b) Engineers (ENGINR)
         c) Field (FIELD)
      2. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
      3. Communication (C)
         a) Back-up Communication (CBU)
      4. Fuel Type (FULTYP). Atomic, fossil (coal, wood, petroleum), hydro, wind, solar, static.
         a) In County Production Capability (INCOPROCAP)
         b) In County Reserves (INCORESV)
         c) In County Demand (INCODEM)
      5. Storage (STORE)
   F. Sixth Level Electrical Facilities (ELECTRICFAC6). Those fixed facilities, personnel, equipment, networks, and easements existing outside of the county available for (or currently) supplying electricity to the county.
      1. Personnel (P)
         a) Logistical (LOGIST)
         b) Engineers (ENGINR)
         c) Field (FIELD)
      2. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
      3. Communication (C)
         a) Back-up Communication (CBU)
      4. Fuel Type (FULTYP). Atomic, fossil (coal, wood, petroleum), hydro, wind, solar, static.
         a) In County Production Capability (INCOPROCAP)
         b) In County Reserves (INCORESV)
         c) In County Demand (INCODEM)
      5. Storage (STORE)
XIV. FOSSIL FUEL (FOSSFUEL). Those fuels within the county utilized in the production of energy, electricity and heat.
   A. Primary Fossil Fuel Status (FOSSFUEL1). To include petroleum, petroleum byproducts and distillates, as well as necessary facilities, equipment and personnel to produce and supply same.
      1. Oils (OIL)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      2. Diesel (DIESEL)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      3. Gasoline (GAS)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      4. Propane (PROPANE)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      5. Natural Gas (NATGAS)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      6. Ethanol (ETHANOL)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
   B. Secondary Fossil Fuel Status (FOSSFUEL2). To include all coals.
      1. Anthracite (ANTH)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      2. Bituminous (BITU)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability
            (STOINCAP). Reserves
         d) County Demand (CDEM)
   C. Tertiary Fossil Fuel Status (FOSSFUEL3). To include wood, pellets, corn, charcoal briquettes, fiber briquettes.
      1. Wood (WOOD)
         a) Production Capability (PRODCAP)
         b) Stock Inventory Demand (STOINCAP)
         c) County Demand
      2. Pellets (PELLETS)
         a) Production Capability (PRODCAP)
         b) Stock Inventory Demand (STOINCAP)
         c) County Demand
      3. Corn (CORN)
         a) Production Capability (PRODCAP)
         b) Stock Inventory Demand (STOINCAP)
         c) County Demand
      4. Charcoal Briquettes (CHARBRQT)
         a) Production Capability (PRODCAP)
         b) Stock Inventory Demand (STOINCAP)
         c) County Demand
      5. Fiber Briquettes (FIBRBRQT)
   D. Quaternary Fossil Fuel Status (FOSSFUEL4). To include those radioactive elements as well as necessary facilities, equipment, and personnel to produce and supply same.
      1. Uranium (URANIUM)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      2. Plutonium (PLUTONIUM)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
      3. Medical Radioactive Derivatives (MEDRADDER)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
   E. Fifth Level Fossil Fuel Status (FOSSILFUEL5). To include hydrogen as well as necessary facilities, equipment, and personnel to produce and supply same.
      1. Hydrogen (HYDROGEN)
         a) Production Capability (PRODCAP)
            (1) Production Equipment Production Capabilities (PEPC)
            (2) Production Equipment Spare Parts Capabilities (PESPC)
            (3) Production Equipment Repairmen (PEREP)
         b) Refinement Capability (REFINECAP)
            (1) Production Equipment Production Capabilities (PEPC)
            (2) Production Equipment Spare Parts Capabilities (PESPC)
            (3) Production Equipment Repairmen (PEREP)
         c) Stock Inventory Capability (STOINCAP). Reserves
         d) County Demand (CDEM)
XV. SANITATION (SAN). That sanitary disposal and/or removal of human waste from within the county.
   A. Primary County Sanitation Status (SAN1). The city, township, or village requiring the largest supply/demand within the county.
      1. In City Fixed Sewage Systems (INCITYFXSWGSYS)
         a) In City Sewage Mains (INCITYSWGMAIN)
            (1) Spare Parts Capabilities (SPPARCAP)
            (2) Repairmen Capabilities (RPMENCAP)
         b) In City Sewage Tanks (INCITYSWGTNK)
            (1) Spare Parts Capabilities (SPPARCAP)
            (2) Repairmen Capabilities (RPMENCAP)
         c) In City Sewage Refineries (INCITYSWGREFIN)
            (1) Spare Parts Capabilities (SPPARCAP)
            (2) Repairmen Capabilities (RPMENCAP)
         d) In City Septic Tanks (INCITYSEPTTNK), non-centralized
            (1) Serviceability (SRVCAB)
         e) In City Drain Fields (INCITYDRNFLD), non-centralized
      2. In City Mobile Sewage Systems (INCITYMOBSWGSYS). Large scale mobile systems within the city able to service sectors of the sewage grid or large off-grid tanks.
         a) In City Mobile Sewage Tankers (INCITYMOBSWGTNK)
            (1) Spare Parts Capabilities (SPPARCAP)
            (2) Repairmen Capabilities (RPMENCAP)
         b) In City Mobile Sewage Refineries (INCITYMOBSWGREFIN)
            (1) Spare Parts Capabilities (SPPARCAP)
            (2) Repairmen Capabilities (RPMENCAP)
      3. Residential Sewage Systems (RESSWGSYS)
         a) Septic Tank (SEPTTNK)
         b) Drain Fields (DRNFLD)
         c) Out Houses (OUTHSE)
         d) Portable Outhouses (PORTOUTHSE)
         e) Incinerators (INCIN)
         f) Other (OTHER)
      4. Out of City Fixed Sewage Systems (OUTCITYFXSWGSYS)
         a) Out of City Sewage Mains (OUTCITYSWGMAIN)
         b) Out of City Sewage Tanks (OUTCTYSWGTNK)
         c) Out of City Sewage Refineries (OUTCITYSWGREFIN)
      5. Out of City Mobile Sewage Systems (OUTCITYMOBSWGSYS). Large scale mobile systems responding to the city able to service sectors of the sewage grid or large off-grid tanks.
         a) Out of City Mobile Sewage Tankers (OUTCITYMOBSWGTNK)
            (1) Spare Parts Capabilities (SPPARCAP)
            (2) Repairmen Capabilities (RPMENCAP)
         b) Out of City Mobile Sewage Refineries (OUTCITYMOBSWGREFIN)
            (1) Spare Parts Capabilities (SPPARCAP)
            (2) Repairmen Capabilities (RPMENCAP)
         c) Out of City Portable Outhouse Systems (OUTCITYPORTOUTHSESYS)
            (1) Serviceability (SRVCAB)
XVI. COUNTY BANK (CBANK). Those net assets of all varieties which exist within the county.
   A. Primary County Bank Status (CBANK1). To include all non-currency net assets which exist within the county. Three columns will display total, county owned, and non-county owned.
      1. Commodities (COMMOD). To include water, food, precious metals, fossil fuels, manufactured goods.
         a) County Water (CWATER). Net
            (1) Production Capability (PRODCAP)
            (2) Stock Inventory Capability (STOINCAP)
         b) County Food (CFOOD). Net
            (1) Production Capability (PRODCAP)
            (2) Stock Inventory Capability (STOINCAP)
         c) County Precious Metals (CPRECMET). Net
            (1) Production Capability (PRODCAP). To include crude reserves and subsequent refinement.
            (2) Stock Inventory Capability (STOINCAP). To include that already refined.
         d) Fossil Fuels (FOSSFUEL). Net
            (1) Production Capability (PRODCAP)
            (2) Stock Inventory Capability (STOINCAP)
         e) Manufactured Goods (MFGGOOD). Net
            (1) Production Capability (PRODCAP)
            (2) Stock Inventory Capability (STOINCAP)
      2. Non Commodities (NONCOMMOD). To include stocks and bonds.
         a) Stocks (STOCKS). Net
            (1) In County Corporation Base (INCOUNCORPBAS)
            (2) Out of County Corporation Base (OUTCOUNCORPBAS)
         b) Bonds (BONDS). Net
            (1) In County (INCOUN)
            (2) Out County (OUTCOUN)
            (a) County (COUN)
            (b) State (STATE)
            (c) Federal (FED)
            (d) Foreign (FOREIGN)
   B. Secondary County Bank Status (CBANK2). To include all currency broker (and branch) net assets which exist within the county. Three columns will display total, county owned, and non-county owned.
      1. County Bank Facility A (CBFA). To represent that bank facility within the county found to be in possession of largest amount of net currency. Subsequent bank facilities will be so ordered according to net currency.
         a) U.S. Federal Reserve Note Currency in Dollars (DOLLARS). Net
            (1) Beginning Day (BEGIN), a twenty-four hour period
            (2) Ending Day (END), a twenty-four hour period
            (3) Profit (PROFIT), a twenty-four hour currency profit earned per facility
         b) Foreign Currency (FORCURR). Net. Two columns will display currency name and net value in dollars.
            (1) Beginning Day (BEGIN), a twenty-four hour period
            (2) Ending Day (END), a twenty-four hour period
            (3) Profit (PROFIT), a twenty-four hour currency profit earned per facility
   C. Tertiary County Bank Status (CBANK3). To include commodities, non-commodities and currency provided to county by various out of county mobile response entities (military agencies, federal agencies, international agencies, Red Cross, and others). Two columns will display net and/or debt.
      1. Commodities (COMMOD). To include water, food, precious metals, fossil fuels, manufactured goods.
         a) County Water (CWATER). Net
            (1) Production Capability (PRODCAP)
            (2) Stock Inventory Capability (STOINCAP)
         b) County Food (CFOOD). Net
            (1) Production Capability (PRODCAP)
            (2) Stock Inventory Capability (STOINCAP)
         c) County Precious Metals (CPRECMET). Net
            (1) Production Capability (PRODCAP). To include crude reserves and subsequent refinement.
            (2) Stock Inventory Capability (STOINCAP). To include that already refined.
         d) Fossil Fuels (FOSSFUEL). Net
            (1) Production Capability (PRODCAP)
            (2) Stock Inventory Capability (STOINCAP)
         e) Manufactured Goods (MFGGOOD). Net
            (1) Production Capability (PRODCAP)
            (2) Stock Inventory Capability (STOINCAP)
      2. Non Commodities (NONCOMMOD). To include stocks and bonds.
         a) Stocks (STOCKS). Net
            (1) In County Corporation Base (INCOUNCORPBAS)
            (2) Out of County Corporation Base (OUTCOUNCORPBAS)
         b) Bonds (BONDS). Net
            (1) In County (INCOUN)
            (2) Out County (OUTCOUN)
            (a) County (COUN)
            (b) State (STATE)
            (c) Federal (FED)
            (d) Foreign (FOREIGN)
      3. County Bank Facility A (CBFA). To represent that bank facility within the county found to be in possession of largest amount of net currency. Subsequent bank facilities will be so ordered according to net currency.
         a) U.S. Federal Reserve Note Currency in Dollars (DOLLARS). Net
            (1) Beginning Day (BEGIN), a twenty-four hour period
            (2) Ending Day (END), a twenty-four hour period
            (3) Profit (PROFIT), a twenty-four hour currency profit earned per facility
         b) Foreign Currency (FORCURR). Net. Two columns will display currency name and net value in dollars.
            (1) Beginning Day (BEGIN), a twenty-four hour period
            (2) Ending Day (END), a twenty-four hour period
            (3) Profit (PROFIT), a twenty-four hour currency profit earned per facility
XVII. NUCLEAR (NUKE). To include all aspects and contingency consideration for nuclear detonation(s) and accidents of various magnitudes within the county. This category will utilize any and all pre-existing categories in its own county specific sub-categorical contingencies.
XVIII. BIOLOGICAL (BIO). To include all aspects and contingency consideration for major county incidents of biological warfare beyond the capabilities of Category XII. To include all quarantine (QUAR) provisions. This category will utilize any and all pre-existing categories in its own county specific sub-categorical contingencies.
XIX. CHEMICAL (CHEM). To include all aspects and contingency consideration for major county incidents of chemical warfare beyond the capabilities of category XII. This category will utilize any and all pre-existing categories in its own county specific sub-categorical contingencies.
XX. MORGUE (MORGUE). To include those facilities, personnel and equipment within the county charged with human and animal corpse removal and/or disposal.
   A. Primary Morgue Facility Status (MORGFAC1). Those fixed structures, personnel, and equipment (currently or readily) within the county, able to provide morgue, autopsy lab, crematory, embalming, and burial at one location.
      1. Capacity (CAP)
      2. Personnel (PERS)
         a) Medical Examiner (ME)
         b) Medical Examiner Tech (METECH)
         c) Embalmer (EMBALM)
         d) Cremator (CRMTR)
      3. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
         d) As Is Capability—Necessary Accessory Surplus Stock (ASISCAP)
            (1) Manufacture Capabilities (MANCAP)
            (2) Amount on Hand (AMONHAN)
      4. Transportation (T)
   B. Secondary Morgue Facility Status (MORGFAC2). Those fixed structures, personnel, and equipment within the county, able to provide one or more morgue duties (storage, autopsy lab, crematory, embalming, and/or burial).
      1. Capacity (CAP)
      2. Personnel (PERS)
         a) Medical Examiner (ME)
         b) Medical Examiner Tech (METECH)
         c) Embalmer (EMBALM)
         d) Cremator (CRMTR)
      3. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
         d) As Is Capability—Necessary Accessory Surplus Stock (ASISCAP)
            (1) Manufacture Capabilities (MANCAP)
            (2) Amount on Hand (AMONHAN)
      4. Transportation (T)
   C. Tertiary Morgue Facility Status (MORGUEFAC3). Those mobile structures, personnel, and equipment within the county, able to provide morgue, autopsy lab, crematory, and embalming services from one self-contained self-sustaining unit.
      1. Capacity (CAP)
      2. Personnel (PERS)
         a) Medical Examiner (ME)
         b) Medical Examiner Tech (METECH)
         c) Embalmer (EMBALM)
         d) Cremator (CRMTR)
      3. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
   d) As Is Capability—Necessary Accessory Surplus Stock (ASISCAP)
      (1) Manufacture Capabilities (MANCAP)
      (2) Amount on Hand (AMONHAN)
      4. Transportation (T)
   D. Quaternary Morgue Facility Status (MORGUEFAC4). Those primary morgue facilities (MORGUEFAC1) located outside the county.
      1. Capacity (CAP)
      2. Personnel (PERS)
         a) Medical Examiner (ME)
         b) Medical Examiner Tech (METECH)
         c) Embalmer (EMBALM)
         d) Cremator (CRMTR)
      3. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
         d) As Is Capability—Necessary Accessory Surplus Stock (ASISCAP)
            (1) Manufacture Capabilities (MANCAP)
            (2) Amount on Hand (AMONHAN)
      4. Transportation (T)
   E. Fifth Level Morgue Facilities (MORGUEFAC5). Those secondary morgue facilities (MORGUEFAC2) located outside the county.
      1. Capacity (CAP)
      2. Personnel (PERS)
         a) Medical Examiner (ME)
         b) Medical Examiner Tech (METECH)
         c) Embalmer (EMBALM)
         d) Cremator (CRMTR)
      3. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
         d) As Is Capability—Necessary Accessory Surplus Stock (ASISCAP)
            (1) Manufacture Capabilities (MANCAP)
            (2) Amount on Hand (AMONHAN)
      4. Transportation (T)
   F. Sixth Level Morgue Facilities (MORGUEFAC6). Those mobile structures located outside the county able to provide morgue, autopsy lab, crematory, and embalming services from one self-contained self-sustaining unit.
      1. Capacity (CAP)
      2. Personnel (PERS)
         a) Medical Examiner (ME)
         b) Medical Examiner Tech (METECH)
         c) Embalmer (EMBALM)
         d) Cremator (CRMTR)
      3. Equipment (EQ)
         a) Manufacture Capabilities (MANCAP)
            (1) Within Facility (INFAC)
            (2) Within County (INCOUN)
         b) Spare Parts Capabilities (SPPARCAP)
            (1) Within Facility (INFAC)
            (2) Within County (INCOUN)
         c) Repairmen Capabilities (RPMENCAP)
            (1) Within Facility (INFAC)
            (2) Within County (INCOUN)
         d) As Is Capability—Necessary Accessory Surplus Stock (ASISCAP)
            (1) Manufacture Capabilities (MANCAP)
            (2) Amount on Hand (AMONHAN)
      4. Transportation (T)
   G. Seventh Level Morgue Facilities (MORGUEFAC7). To include non-traditional equipment, methods, and locations as well as personnel for large scale mass burial, storage, and/or cremation.
      1. Method (METH)
         a) Storage (STOR)
         b) Burial (BUR)
         c) Cremation (CRM)
      2. Location (LOC)
         a) Storage (STOR)
         b) Burial (BUR)
         c) Cremation (CRM)
      3. Equipment (EQ)
         a) Storage (STOR)
         b) Burial (BUR)
         c) Cremation (CRM)
      4. Personnel (PERS)
         a) Storage (STOR)
         b) Burial (BUR)
         c) Cremation (CRM)

In regard to Claim Number Sixteen, six thousand three hundred and eighty-four network ROOTFILES are utilized for county (6282), State (100) and Federal (2) organization. One for NETWORKCATALOGED out of network access and one for CATALOGEDNETWORK access to edited files. Out of network input will utilize RDDWR access. Network access to out of network databases will utilize DDWDR and FILETRANSFER. The internet is the primary form of transmission (FT). The numerous Communication (C) subcategories will provide a format for the “As Needed” implementation of the other various methods, modes, and means of communication (FFDI/FFDS/FFDR—FT) as each scenario so demands.

In regard to Claim Number Seventeen, a number of examples and descriptions will provide further detail into the actualized presentation of 1234ABCDCOUNTYSTATUS. Just as MAPOFFICELOCATION is available at IFSLGOVWATCH, a similar feature is available at 1234ABCDCOUNTYSTATUS.

### EXAMPLE 1

“Map burn bed availability at secondary medical facilities (MF2)” would provide a back-drop of county geographic and each secondary medical facility (MF2) with burn beds available would be superimposed. Along with facility identification visual will be text with up-to-date information as to the number currently available and other pertinent data further superimposed on map.

### EXAMPLE 2

“Map burn bed availability at sixth level medical facility A (MF6/A/BAPF/BUB), Off-duty burn nurses (MP2/NUR/BU), empty school busses (MT3/TRB/SCBUS) and mobile burn tubs (MEQ4/BUTUB)” All five maps will provide SUPERIMPOSITION graphics to pinpoint locations and text will also be provided with further detailed data, including contact information (C, and CMF6ABU).

### EXAMPLE 3

Referring back to example 2, the same data and graphics could be immediately displayed for surrounding counties individually or four simultaneously (utilizing four separate Linux accounts) on a QUADSCREEN, simply by entering access codes for surrounding counties and applying the identical map search to each selected county file server accessed.

### EXAMPLE 4

Regarding the several counties surrounding Detroit in an extreme scenario, should Fermi II melt down with a south wind, major roads and primary communications out, the most recent (twelve hour old) paper copy print-out of county status will be referenced and various back-up communication algorithms will be followed. Surrounding county status networks which are intact can provide available information from Environmental Watch (and elsewhere) and transmit said data into effected counties according to back-up communication algorithms (CBU) regardless of (FFDI/FFDR) or forms of transmission (FT).

Examples of how files within the twenty categories are to be identified (addressed) as follows:
a. The number of orthopedic surgeons located at primary medical facility X will be located in the following file: MF1/X/MP1/PHYS/SUR/ORT/.
b. To determine the number of radiation beds available for general surgery brought into the county from FEMA compared to the number of off-duty general surgeons in the county will to incur radiation exposure, two filed would be accessed: MF6/FEMA/BAPF/OPRB/GEN/RAD and MP2/PHYS/SUR/GEN/RAD.

The sheriff will be provided an ordered, universal, one page (screen) of data displaying all twenty categories (and various default subcategories) in rows and colurns providing numerics and letters as to so indicate a broad detailed, yet simplistic overview of the county status according to all twenty categories. Once acquainted with this ordered, universal format, a momentary glance should suffice during periods of low level incidents. Each category and subcategory can, of course, be further accessed for more detail specific information.

County run forms will provide the same universal front page provided to the sheriff, in several lesser degrees of detail, to all workers within the twenty categories. The body of the form will be for narratives. In the lower left corner will be a geographic map of the county. Within this map will be room for all twenty categories to provide brief, generic data on each category's activity over the past twenty-four hours. The run forms will provide one higher level of detail than that listed below for generic, general public page, but of the identical universal order and format and printed daily from 1234ABCDCOUNTYSTATUS. Thus, all workers in all categories within the county will literally be on the same page by being provided up to date county status for all categories.

County triage tags will utilize standard four level triage with provisions for rapid category and personnel identification.

1234ABCDCOUNTYSTATUS will provide one (internet based) generic screen for all county residents to view. Detailed below are items to be on that screen.

The medical facility category will provide a fuel gauge graphic with normal operation indicating full and sixth level medical facility mobilization indicating empty. Similar fuel gauge graphics will be provided for medical personnel, medical transportation, evacuation, medical equipment, pharmacy and communications.

County water category will provide numerics consisting of gallons used within the county over previous twenty-four hours. This will then be superimposed on a fuel gauge graphic which symbolizes full when production capacity is at maximum. Needle will indicate water used within the county over past twenty-four hours.

County food category will provide fuel gauge graphic. Full will symbolize normal supply (total). Empty will indicate no supply and needle will indicate demand.

County animal category will provide a fuel gauge graphic. Full will symbolize county food, water, and medical manufacture is equal to demand with evacuation plans in place. Needle will indicate level according to conformity with full over past twenty-four hours.

County criminal justice status will provide a fuel gauge graphic. Full will symbolize county food, water, and medical manufacture is equal to demand with evacuation plans in place. Needle will display level according to conformity with full over past twenty-four hours.

County public safety status will provide a fuel gauge graphic. Full will symbolize total county capacity. Needle will indicate utilized resources (as contrasted to capacity) over previous twenty-four hours.

County electricity status will provide a fuel gauge graphic. Full will symbolize total county demand capacity. Needle will indicate county supply capabilities over past twenty-four hours. Superimposed on fuel gauge will be amount of electricity utilized over past twenty-four hours in Kilowatts. Counties which import electricity in bulk will, of course, display a needle on empty.

County fossil fuel status will provide a fuel gauge graphic. Full will symbolize fossil fuel consumption daily average. Needle will indicate production and refinement capability (totals) within the county over previous twenty-four hours.

County sanitation status will provide a fuel gauge graphic. Full will symbolize county supply/demand daily average. Needle will indicate county capability for non-reliance on centralized (city) system.

County bank status will provide two pie graphs. One will display in county net assets (non-currency and currency) and the second will display in county assets (non-currency and currency) with out of county owners. Both pie graphs will display numerics in dollars (below) of previous twenty-four hour status.

County NUKE status will provide a fuel gauge graphic. Full will symbolize total preparedness (Evacuation and contingencies). Needle will indicate current county preparedness and a direct ICN link to ISBN 0-942487-01-X will provide complete online text of book.

County wide BIO status will provide a fuel gauge graphic. Full will symbolize total preparedness (Evacuation, Quarantine, and contingencies). Needle will indicate current county preparedness.

County wide CHM status will provide a fuel gauge graphic. Full will symbolize total preparedness (evacuation and contingencies). Needle will indicate current county preparedness.

County wide morgue status will provide a fuel gauge graphic. Full will symbolize total preparedness. Needle will indicate current county preparedness.

Spokesmen in all categories will be provided back-up communication (CBU) and will also oversee communication (C) and back-up communication (CBU) for assigned categories.

1234ABCDCOUNTYSTATUS will also provide capabilities for momentary and hourly updates from all categories and subcategories which will then display a more dynamic needle indicator for the general public to view on the generic screen page.

Each applicable category and subcategories can access maps to identify various selected infrastructure and sub-infrastructure.

In regard to Claim Number Eighteen, an internet based ZONE of IFSLGOVWATCH will provide five hundred and seventy-six network ROOTFILES. Each of the sixteen volumes has the thirty-six mapping files available and specific to the content (topic) of each volume. The internet based aspect (vectorized) allows for SUPERIMPOSITION of any and all of the thirty-six mapping categories as applicable. The hardcover series will be of excellent quality (image, paper, binding, cover) and will be available in thirteen by nine inches with approximately two hundred color glossy pages. The consumer will select the choice of mapping categories and/or subcategories. Default setting will provide a standard which can be obtained as is or altered. The TRANSPARENCY series will be of excellent quality (image, paper, binding, cover) and will be available in eight and one half by eleven with approximately three hundred pages—two hundred of which will be color glossy and one hundred of which will be of TRANSPARENCY. The consumer will select the choice of mapping categories and/or subcategories for both page and TRANSPARENCY. Default settings will provide a standard which can be obtained as is, or altered. File partitions provide for NETWORKCATALOGED out of network access and for CATALOGEDNETWORK access to edited files.

In regard to Claim Number Nineteen, an internet based ZONE of IFSLGOVWATCH will provide four hundred and thirty-two network ROOTFILES (of the above five hundred and seventy-six). This claim provides identical parameters and scope as in above paragraph and so applied to the twelve volumes.

In regard to Claim Number Twenty, an internet based ZONE of IFSLGOVWATCH will provide one hundred and forty-four network ROOTFILES (of the above five hundred and seventy-six). Partitions will provide for NETWORKCATALOGED out of network access and for CATALOGEDNETWORK access to edited files for each Nation, State, County, and City.

The National Atlas (volume thirteen) provides the International consumer an entire volume devoted to the selected Nation (of those on earth) as well as selection of superimposed MAP CATEGORIES and, of course, selection of language.

The State Atlas (volume fourteen) refers to the fifty U.S. States, as well as to (internationally speaking) that first geographic subdivision below Nation (i.e. Province, etc.) and provides consumer an entire volume devoted to the selected State as well a selection of superimposed MAP CATEGORIES and, of course, selection of language.

The County Atlas (volume fifteen) refers also to parishes and (internationally speaking) that second geographic subdivision below Nation but above city (boundaries which encompass city boundaries). A subdivision of the County Atlas is the TRANSPARENCY plat book, which like the County Atlas is provided to and for each County in the U.S. (an example of the TRANSPARENCY plat book would be to provide a base page photographic image of a vectorized section taken during non-foliated winter (MAPPING 34) with topographic (MAPPING 4) and hydrographic (MAPPING 6) superimposed into base page image. The first TRANSPARENCY leaf would consist of full color summertime foliage (MAPPING 34), the second TRANSPARENCY displaying two-track roads (MAPPING 1) and hiking paths (MAPPING 2) could then be layered over, and a third TRANSPARENCY would indicate property owners. These updated transparencies could be ordered in their various combinations of superimposed MAP CATEGORIES and this example explains (on a county level) how these layered TRANSPARENCY inserts could be designed and utilized within the other fifteen volumes, whether within the pages of hard over book binding, electronically or TRANSPARENCY insert format.

The City Atlas (volume sixteen) refers to any city, town, village or township—that smallest geo-governmental unit, currently or previously existing on the earth. This atlas provides detailed emphasis on infrastructure mapping subcategories.

### EXAMPLE 1

City TRANSPARENCY atlas would provide a block by block photo image base page (MAPPING 28) with layered leaf TRANSPARENCY inserts of water mains (MAPPING 15 SUB 1) and/or sewer lines (MAPPING 15 SUB 2) and/or gas lines (MAPPING 15 SUB 3) and/or electric lines, transformers and subs (MAPPING 15 SUB 4) and/or subway (MAPPING 15 SUB 7) and/or mines (MAPPING 5) and/or multilevel owner plat/plot (MAPPING 9) and/or lessees/lessors (MAPPING 9).

### EXAMPLE 2

city atlas which combines encyclopedia and TRANSPARENCY. The city mayor may have a two hundred page hard cover 13″×9″ city atlas with detailed photographic images superimposed with selected MAP CATEGORIES (road names, topography) and layered TRANSPARENCY leafs of electrical infrastructure (MAPPING 15 SUB 4) and then property owners (MAPPING 9).

The above should provide examples of how the atlas (encyclopedic, electronic, and TRANSPARENCY) is designed to be utilized in the other fifteen volumes.

In regard to Claim Number Twenty-one, this refers to the textual commentaries of excellent quality that will accompany images throughout the sixteen volumes, whether in printed, electronic, or TRANSPARENCY format. This character or text is located in mapping file thirty-six and available in various (selected) languages of the Earth.

In regard to Claim Number Twenty-two, ULTRAFINE latitude and longitude precision refers herein to providing terrestrial county plat map detail upon the listed celestial objects, providing applicable map category SUPERIMPOSITION at that level in atlas volumes (encyclopedic, electronic, TRANSPARENCY).

In regard to Claim Number Twenty-three, two network ROOTFILES are provided; one for NETWORKCATALOGED out of network access and one for CATALOGEDNETWORK access to edited files. This internet based tool provides file partitions for the various host addresses which are accessed via DDWR. An icon titled Outer Space Live opens a menu of the various hosts. The hosts will be organized by proper name (alphabetics), Nation of ownership, agency, type, class, perspective, and cost—total and annual. This menu is of icon format. Also a RVRS link will be available (in the form of an icon) to provide access to the various agency divisions' official web sites.

1. IFSLGOVWATCH claims to provide new and improved, useful methods of access, editing, and presentation of data acquired from geo-governmental sources (as would a newly invented useful tool) utilizing known methods and means of data acquisition and dissemination (by utilizing RVRS, DRVS, DDWR, RDDWR, DDWDR, DDWDR1, DDWDR2, DDWDR3, FILETRANSFER, CONFIGGNTOOON, CONFIGOONTON, MAPOFFICELOCATION, LANGUAGEFI, MPGVAC, QUADSCREEN, FFDI, FFDR, FFDS, FT, NETWORKCATALOGED, DOWNLOADABLE, VIDEOLI, AUDIOLI, CHARACTERLI, CATALOGEDNETWORK, UNFI, IFI, FFI, SFI, LFI, AGENCYFI, NONAGENCYFI, TREASURYFI, CRIMESTATSFI, JUDICIALRULINGFI, MAPFI, PICTUREFI, GRAPHICFI, VIDEOFI, AUDIOFI, CHARACTERFI, LEGISLATIONFI, CONSTITUTIONFI, VDATE, ADATE, CDATE, HDATE (Files, Past), PAGES of STUF, TREATYFI, CALENDARFI, DEMOGRAPHICLEVEL, PROFILEFI, NEWSDATEFI, and LINUX for its tangible application operation) from governmental networks and databases across the globe. This new and usefuil tool is designed to work with governments and governmental affairs at Local, State, Federal, International, and UN levels and will be available TWENTYFOURSIX.

2. IFSLGOVWATCH will provide new and improved, useful methods of access and presentation (FFDI/FFDS/FFDR via FT) of geo-governmental affairs through internet based NETWORKCATALOGED out of network access to all live and filed out of network maps, pictures, graphics, video, audio and character generated by government (main braches, agencies, non agencies) at a UN, International, Federal, State and Local level and is to be titled IFSLGOVWATCHCENTRAL.

3. IFSLGOVWATCH will provide new and improved, useful methods of access, editing and presentation (FFDI/FFDS/FFDR via FT) of geo-governmental affairs through internet based network access to its own edited PAGES of STUF (network) files created for each aspect of government (main branches, agencies, non agencies) at a UN, International, Federal, State and Local level as well as providing NETWORKCATALOGED icon link options for access to the various corresponding (out of network) official governmental web sites and to be titled IFSLGOVWATCHMAIN.

4. IFSLGOVWATCH will provide new and improved, useful editing and presentation of geo-governmental affairs through a multifaceted (GWNN, HDATEFILES, AND GWMAG) multimedia (FFDI/FFDS/FFDR via FT) based news network, entirely dedicated to and solely focused upon the coverage and reporting of all aspects of governmental affairs (main branches, agencies, non agencies) at a UN, International, Federal, State, and Local level.

5. IFSLGOVWATCH will provide new and improved, useful methods of access, editing, and presentation (FFDI/FFDS/FFDR via FT) of geo-governmental affairs through internet based, individually edited PAGES of STUF (network) files titled, “Who are my Politicians?”, unique to each network registered individual.

6. IFSLGOVWATCH will provide new and improved, useful methods of access, editing, and presentation (FFDI/FFDS/FFDR via FT) of geo-governmental affairs through internet based, edited PAGES of STUF (network) files titled “View Calendars” as well as a political calendar unique to each network registered individual.

7. IFSLGOVWATCH will provide new and improved, useful methods of access, editing, and presentation of (FFDI/FFDS/FFDR via FT) geo-governmental affairs through internet based NETWORKCATALOGED access to out of network files and/or CATALOGEDNETWORK access to edited files titled View Constitution, which provides immediate access to any and all governmental constitutions at a UN, International, Federal, State and Local level.

8. IFSLGOVWATCH will provide new and improved, useful methods of editing and presentation (FFDI/FFDS/FFDR via FT) of geo-governmental affairs by publishing trading card style biographies for all elected or appointed governmental employees (main branches, agencies, non agencies, non governmental agencies), subcontractors, geographies and political structures with pertinent bio-demographic information at a UN, International, Federal, State, and Local level, to be titled IFSLGOVWATCH Trading Cards.

9. IFSLGOVWATCH will provide new and improved, useful methods of access, editing, and presentation (FFDI/FFDS/FFDR via FT) of geo-governmental affairs through internet based edited PAGES of STUF (network) files combined with live (and/or recently updated) data from private or public (Federal, State and Local environmental agencies) air, ground and water quality monitors further combined with live (and/or recently updated) data from private or public (NOAA, National Weather Service) weather agencies to produce atmospheric, hydrologic and ground pollution diffusion forecasts, projections and models, to be titled ENVIRONMENTWATCH.

10. IFSLGOVWATCH will provide new and improved, useful methods of access, editing, and presentation (FFDI/FFDS/FFDR via FT) of geo-governmental affairs through internet based network access to its own edited PAGES of STUF (network) files created for each subcontracted entity of government (main branches, agencies, non agencies), at a UN, International, Federal, State and Local level, as well as providing NETWORKCATALOGED icon link options for access to the various corresponding out of network, official subcontracted entities' websites and to be titled SUBWATCH.

11. IFSLGOVWATCH will provide new and improved, useful methods of access, editing, and presentation (FFDI/FFDS/FFDR via FT) of geo-governmental affairs through internet based CATALOGEDNETWORK access to its own edited PAGES of STUF files created for each pathogen (viral, bacterial, mycoplasm, fungus, prion) and non-pathogen (chemical, radiation, electromagnetic frequencies) for precise collection, dissemination, forecasts, projections and review of epidemiological data at an International, Federal, State and Local level, as well as providing NETWORKCATALOGED access to the various corresponding out of network official governmental websites, to be titled EPIDEMIOLOGY WEEKLY.

12. IFSLGOVWATCH will provide new and improved, useful methods of access and presentation (FFDI/FFDS/FFDR via FT) of geo-governmental related affairs through internet based NETWORKCATALOGED, icon link options for DDWR access to all live “streaming” audio (live radio station broadcasts) and video (live television station broadcasts) at an International, Federal, State, and Local level, to be titled STREAMING AUDIO CENTRAL.

13. IFSLGOVWATCH will provide new and improved, useful methods of access, editing, and presentation (FFDI/FFDS/FFDR via FT) of geo-governmental affairs through multimedia (CATALOGEDNETWORK) access to its own edited PAGES of STUF files created for each possible aspect of motor vehicle accidents' causes and effects for training (MVACET) at an International, Federal, State, and Local level, as well as providing NETWORKCATALOGED icon link options for access to the various corresponding out of network governmental (main branches, agencies, non agencies) websites, to be titled MVACET.

14. IFSLGOVWATCH will provide new and improved, useful methods of access, editing, and presentation (FFDI/FFDS/FFDR via FT) of geo-governmental affairs through internet based CATALOGEDNETWORK access to network and/or NETWORKCATALOGED access to out of network map files (MAPFI) and video files (VIDEOFI) which display virtual tours of all cities (current, past, populated or unpopulated) known (submersed, under, or) on the earth, a graffiti watch blog site for each city, NETWORKCATALOGED access to all out of network live video from public and/or private traffic jam cameras at an International, Federal, State, and Local level and to be titled SEE THE WORLD FOR FREE.

15. 1234ABCDCOUNTYSTATUS provides new and improved, useful methods of access, editing and presentation (FFDI/FFDS/FFDR via FT) of geo-governmental affairs through an internet based tool for disaster management at the county level by utilizing a framework of twenty main categories (and their respective subcategories) in such a way as to present an updated and ongoing, detailed, simplistic account of county emergency preparedness to the county sheriff (FFDR), from multiple inputs (FFDI) via the various forms of transmission (FT) as a DNS ZONE of IFSLGOVWATCH.

16. 1234ABCDCOUNTYSTATUS provides new and improved, useful methods of access and editing of geo-governmental affairs through a practical application of its methodically unique tool, by utilizing known methods and means of transmitting, storing and receiving information (FFDR/FFDS/FFDI) via the various forms of transmission (FT) in order to retrieve out of network database files (DDWDR, FILETRANSFER), visit out of network hosts (DDWDR), access out of network live video and audio (DDWR), provide for secure out of network access to network file server (RDDWR), as well as access to network database (DRVS).

17. 1234ABCDCOUNTYSTATUS provides new and improved, useful methods of editing and presentation (FFDI/FFDS/FFDR via FT) of geo-governmental affairs by organizing the collection of data from the twenty main categories (and their respective subcategories) so as to present the general public, the personnel within the categories, public safety workers, as well as the sheriff, with the exact same daily data, in the same universal format, in varying degrees of complexity on universal run forms, compatible triage tags, computers and other (FFDR), via the various forms of transmission (FT).

18. The Home Atlas Encyclopedia to the Solar System and Earth provides new and improved, useful methods of access, editing, and presentation of (FFDI/FFDS/FFDR via FT) geo-celestial governmental affairs in a sixteen volume custom designed ENCYCLOPEDIC ATLAS and/or ELECTRONIC ATLAS and/or TRANSPARENCY ATLAS of the universe, solar system and earth, from FOIA'd maps, which allows the consumer to pick and choose various MAP CATEGORIES for SUPERIMPOSITION on each individual volume—the last four of which are custom, specific to a selected geographic location—all sixteen will PUBLISH edited character and to be approximately two hundred color glossy pages.

19. The Home Atlas Encyclopedia to the Solar System and Earth provides new and improved, useful methods of access, editing, and presentation of (FFDI/FFDS/FFDR via FT) geo-celestial governmental affairs in the first twelve volumes of the custom designed ENCYCLOPEDIC ATLAS and/or ELECTRONIC ATLAS and/or TRANSPARENCY ATLAS, by providing SUPERIMPOSITION of MAP CATEGORIES for each volume, which is in turn to provide content corresponding to the volume title—namely: The Universe, The Sun, Mercury, Venus, Earth, Mars, Asteroids Meteors and Space Junk, Jupiter, Saturn, Uranus, Neptune, Pluto.

20. The Home Atlas Encyclopedia to the Solar System and Earth provides new and improved, useful methods of access, editing, and presentation (FFDI/FFDS/FFDR via FT) of geo-celestial governmental affairs in the final four volumes of the custom designed ENCYCLOPEDIC ATLAS and/or ELECTRONIC ATLAS and/or TRANSPARENCY ATLAS, by providing SUPERIMPOSITION of MAP CATEGORIES for each volume, which is in turn to provide content corresponding to the volume title, namely: National, State, county, and city.

21. The Home Atlas Encyclopedia to the Solar System and Earth provides new and improved, useful methods of access, editing and presentation (FFDI/FFDS/FFDR via FT) with detailed in-depth commentaries (MAPPING 36 and subcategories) which accompany each celestial object (natural or man made) and PUBLISH edited character for astrological, chemical, hydrological, gravitational, revolutionary, rotational, radiological, spectrologic data FOIA'd, also providing detailed demographic (budgets, personnel, office locations, equipment, technology advances, and purpose), as well as historical profiles on all manned and unmanned landing and orbiting ventures (content to be associated with volume title, except for space junk, which will provide the detailed analysis of each piece in volume 7).

22. The Home Atlas Encyclopedia to the Solar System and Earth provides new and improved, useful methods of access, editing and presentation (FFDI/FFDS/FFDR via FT) as it divides the naturally occurring celestial objects (nine planets—their moons and rings, sun, asteroids, and meteors) with ULTRA FINE latitude and longitude precision and also creates (and names) Nations, States, counties, oceans, seas, bays, rivers, and other landmarks either by latitude/longitude or otherwise, with names being assigned or assimilated.

23. The Home Atlas Encyclopedia to the Solar System and Earth provides new and improved, useful methods of access, editing and presentation with live video (VIDEOLI) and previous video (VIDEOFI) of the Universe, Solar System and Earth via a DDWR or DDWDR (respectively) link to the numerous publicly funded orbiting objects of the U.S. Government (and participating foreign governments) to FFDR/FFDS via FT as well as displaying live orbit path graphics (ORBITLI) and/or previous orbit path graphics (ORBITFI) of all man made terrestrial (including space junk) orbiters (whether foreign or domestic) which is also available to FFDR/FFDS via FT with audio and text, in various languages and levels (MAPPING 36) and accessible at IFSLGOVWATCHCENTRAL (MAPPING 33).
